(19) United States
(12) Patent Application Publication
(10) Pub. No.: US 2026/0008921 A1
(43) Pub. Date: Jan. 8, 2026

(54) PROCESS TO PRODUCE POLYMER COMPOSITIONS COMPRISING POLYETHYLENE

(71) Applicants: TOTALENERGIES ONETECH, Courbevoie (FR); UNIVERSITÉ CLAUDE BERNARD LYON 1 (UCBL), Villeurbanne (FR); INSTITUT NATIONAL DES SCIENCES APPLIQUÉES DE LYON (INSA LYON), Villeurbanne Cedex (FR); UNIVERSITÉ JEAN MONNET SAINT-ETIENNE, Saint-Etienne Cedex 2 (FR); CENTRE NATIONAL DE LA RECHERCHE SCIENTIFIQUE (CNRS), Paris (FR)

(72) Inventors: Olivier LHOST, Seneffe (BE); Yves TROLEZ, Seneffe (BE); Pascal NAVEZ, Seneffe (BE); Philippe CASSAGNAU, Villeurbanne (FR); Mohammad ABOU-TAHA, Marcellaz (FR); Karim DELAGE, Villeurbanne (FR); Emmanuel BEYOU, Villeurbanne (FR)

(21) Appl. No.: 19/119,539

(22) PCT Filed: Oct. 4, 2023
(86) PCT No.: PCT/EP2023/077437

§ 371 Date: Apr. 9, 2025

(30) Foreign Application Priority Data
Oct. 10, 2022 (EP) 22315235.6

(51) Int. Cl. C08L 77/02; C08J 3/20

(52) U.S. Cl. CPC C08L 77/02; C08J 3/201; C08J 2377/02; C08J 2423/06; C08J 2451/06; C08L 2205/03; C08L 2205/08; C08L 2207/062

(57) ABSTRACT

The disclosure relates to a process to produce a polymer composition comprising melt blending from 10 to 90 wt. % of polyethylene resins; from 90 to 10 wt. % of materials selected from materials having a polar functional group, inorganic polar particles, polymers having a polar functional group, HD silica, fumed silica, carbon-containing particles, carbon fibres, glass fibres, natural fibres, and any mixture thereof; from 0.5 to 20 wt. % of a grafted polyethylene, and the compatibilizer is comprising at least 70 wt. % of polyethylene based on the total weight of the compatibilizer, and has a melt index MI2 ranging from 25 to 450.0 g/10 min, an Mw/Mn ranging from 2.0 to 4.5; a complex viscosity at 0.1 rad/sec at 190° C. of at most 25,000 Pa·s; and a grafting agent content ranging from 0.5 to 15.0 wt. % based on the total weight of the compatibilizer.

### TECHNICAL FIELD

The present disclosure relates to polymer compositions comprising polyethylene and one or more materials, produced with the addition of a compatibilizer such as a grafted polyethylene.

### TECHNICAL BACKGROUND

Polymer compositions comprising polyethylene and materials are of particular interest. For example, in compositions comprising polyethylene (PE) and polyamides (PA), polyamides generally exhibit good strength and resistance to hydrocarbon solvents, while polyethylene contributes to low temperature toughness and low moisture sorption, thus by blending new property combinations can be reached. As another example, ethylene vinyl alcohol (EVOH) provides barrier properties so that polymer compositions comprising PE and EVOH are highly desirable in packaging. Also, polymer compositions comprising PE and cellulose derivatives are searched to improve the degradability of plastics.

Polymer compositions comprising blends of polyethylene and other materials such as polymers or materials having a polar functional group or other materials such as carbon-containing material, glass fibre and/or carbon fibres, are therefore used in several different applications fields, like films for packaging, injection and blow moulded articles, extruded sheets, agricultural films, industrial liners, profiles, pipes, etc.

Unfortunately, most of the materials and PEs are highly immiscible resulting in blends with poor adhesion among its phases, coarse morphology and consequently poor mechanical properties.

The compatibility between the phases of such blends can be improved by the addition of compatibilizers, which results in a finer and more stable morphology, better adhesion between the phases of the blends and consequently better properties of the final product.

From the literature several kinds of compatibilizers suitable for such blends are known, like block copolymers or polymers modified by grafting, e.g., maleic anhydride grafted polyethylenes.

For example, F. Zhang et al. in “Mechanochemical preparation and properties of a cellulose-polyethylene composite”. (2001). Journal of Materials Chemistry, 12(1), 24-26, reports the properties of a cellulose-polyethylene composite prepared using maleated polyethylene.

EP3331950 discloses compatible heterogeneous polymer blends of polyethylene and polyamide, whereby the matrix of the blend comprises the polyethylene, which is a special linear low-density polyethylene in native and/or recycled form, optionally in combination with a compatibilizer, whereby preferably the polyamide of the compatible heterogeneous blend is a postconsumer (i.e., recycled) polyamide, which can optionally contain at least one further polymer, like polyethylene. The use of a compatibilizer is said to be optional, the compatibilizer disclosed is a polyethylene grafted with a mono- or polycarboxylic acid compound or a derivative therefrom as the grafting agent.

WO2016025317 describes a linear low-density polyethylene grafted with maleic anhydride (MAH-g-LLDPE). The MAH-g-LLDPE has a unique combination of properties including a low density and a high melt index.

It is known that to the compatibilizer, the mechanical properties are significantly improved by comparison to the blend produced without compatibilization. The advantages frequently reported are a significant increase in the mechanical properties such as the strain at break measured during a test of traction or impact properties. The more significant the improvement of impact properties or the elongation of break, the more interesting is the compatibilizer. Therefore, there is a constant need for processes and compatibilizer that allows for improving the balance of properties and in particular, that allows an improvement of the impact properties.

### SUMMARY

It has now been found that one or more of the above-mentioned needs can be fulfilled by blending polyethylene with one or more other materials and a specific compatibilizer.

According to a first aspect the disclosure provides for a process to produce a polymer composition comprising
providing from 10 to 90 wt. % of a component A based on the total weight of the polymer composition; wherein the component A is one or more polyethylene resins selected from a high-density polyethylene resin, a medium-density polyethylene resin, a low-density polyethylene resin, a linear low-density polyethylene resin and any mixture thereof;
providing from 90 to 10 wt. % of a component B based on the total weight of the polymer composition; wherein the component B is one or more materials selected from materials having a polar functional group, inorganic polar particles, polymers having a polar functional group, high-density silica, fumed silica, carbon-containing particles, carbon fibres, glass fibres, natural fibres, and any mixture thereof;
providing from 0.5 to 20 wt. % of a compatibilizer based on the total weight of the polymer composition; wherein the compatibilizer is a grafted polyethylene, and melt blending the component A, the component B and the compatibilizer to obtain a polymer composition;
   remarkable in that the compatibilizer comprises at least 70 wt. % of polyethylene based on the total weight of the compatibilizer, and has:
a melt index MI₂ ranging from 25 to 450 g/10 min as determined according to ISO 1133-2011 at 190° C. under a load of 2.16 kg;
an Mw/Mn ranging from 2.0 to 4.5;
a complex viscosity at 0.1 rad/sec at 190° C. of at most 15,000 Pa·s; and
a grafting agent content ranging from 0.5 to 15.0 wt. % based on the total weight of the compatibilizer.

Surprisingly, it was found that the use of said compatibilizer in blends comprising polyethylene with one or more polymers having a polar functional group allows for improving the balance of mechanical properties and in particular allows for improving the impact properties of the blend as demonstrated by the examples.

One of the findings of the present invention is that further improvement in the impact properties can be obtained by using specific compatibilizers with higher melt index (see FIG. 13). Since the preparation method allows obtaining compatibilizers being grafted polyethylene with a higher melt index than the ones commercially available, the improvement in the balance of properties reached unprecedented proportions to the knowledge of the Applicant compared to compositions consisting of the same components but another compatibilizer.

### The Polymer Composition and the Process to Produce the Polymer Composition

The component A (i.e., the one or more polyethylene resins) is provided at a content ranging from 10 to 90 wt. % based on the total weight of the polymer composition; preferably, ranging from 20 to 80 wt. %; more preferably ranging from 30 to 70 wt. %; even more preferably ranging from 40 to 60 wt. %, and most preferably ranging from 45 to 55 wt. %.

The component B is provided at a content ranging from 90 to 10 wt. % based on the total weight of the polymer composition; preferably, ranging from 80 to 20 wt. %; more preferably ranging from 70 to 30 wt. %; even more preferably ranging from 60 to 40 wt. %; and most preferably ranging from 55 to 45 wt. %.

The compatibilizer is provided at a content ranging from 0.5 to 20 wt. % based on the total weight of the polymer composition; preferably, ranging from 0.6 to 15 wt. %; more preferably ranging from 0.7 to 10 wt. %; even more preferably ranging from 0.8 to 5 wt. %, and most preferably ranging from 0.9 to 3 wt. %.

For example, the process to produce a polymer composition comprises:
providing from 40 to 60 wt. % of the component A based on the total weight of the polymer composition;
providing from 60 to 40 wt. % of the component B based on the total weight of the polymer composition; and
providing from 0.8 to 5 wt. % of the compatibilizer based on the total weight of the polymer composition.
   The Component a being One or More Polyethylene

In an embodiment, that the one or more polyethylene resins of the component A have a high load melt index (HLMI) of at least 1.0 g/10 min as determined according to ISO 1133-2011 at 190° C. under a load of 21.6 kg and/or a melt index (MI₂) of at most 20.0 g/10 min as determined according to ISO 1133-2005 at 190° C. under a load of 2.16 kg; preferably of at most 3.0 g/10 min.

For example, the one or more polyethylene resins of the component A have a density of at least 0.910 g/cm³ as determined according to ISO 1183-1:2012 at 23° C. and/or a density of at most 0.965 g/cm³ as determined according to ISO 1183-1:2012 at 23° C.

For example, the one or more polyethylene resins are or comprise one or more high-density polyethylene resins and have a density ranging from 0.910 g/cm³ to 0.945 g/cm³ as determined according to ISO 1183-1:2012 at 23° C.; preferably, ranging from 0.912 g/cm³ to 0.940 g/cm³; more preferably, ranging from 0.915 g/cm³ to 0.938 g/cm³; and even more preferably, ranging from 0.918 g/cm³ to 0.935 g/cm³.

In an embodiment, the one or more polyethylene resins of the component A are or comprise one or more high-density polyethylene resins and have a density ranging from 0.940 g/cm³ to 0.965 g/cm³ as determined according to ISO 1183-1:2012 at 23° C.; with preference ranging from 0.948 g/cm³ to 0.960 g/cm³.

### The Component B

The component B is one or more materials selected from materials having a polar functional group, inorganic polar particles, polymers having a polar functional group, HD silica, fumed silica, carbon-containing particles, carbon fibres, glass fibres, natural fibres, and any mixture thereof.

In an embodiment, the polar functional group is at least one selected from the group consisting of a carboxyl group, a hydroxyl group, an epoxy group, an amino group, an amide group, a silyl group, an acetylacetonato group, and a mercapto group; with preference, selected from the group consisting of a carboxyl group, a hydroxyl group, an amino group, and an amide group.

In a preferred embodiment, the one or more polymers having a polar functional group are selected from polyamide, ethylene vinyl alcohol, polyester, cellulose derivative with a hydroxyl group, and any mixture thereof; preferably, selected from polyamide and/or ethylene vinyl alcohol.

For example, the one or more polymers having a polar functional group are or comprise one or more polyamides are selected from PA-6; PA-6,6; PA-6,9; PA-6, 10; PA-6, 12; PA-11; PA-4,6 and PA-66/6 copolymer; with preference, the one or more polyamides are or comprise PA-6

### The Compatibilizer and the Step of Providing a Compatibilizer

According to the disclosure, the compatibilizer is a grafted polyethylene comprising at least 70 wt. % of polyethylene based on the total weight of the compatibilizer and has:
a melt index MI₂ ranging from 25 to 450.0 g/10 min as determined according to ISO 1133-2011 at 190° C. under a load of 2.16 kg;
an Mw/Mn ranging from 2.0 to 4.5;
a complex viscosity at 0.1 rad/sec at 190° C. of at most 15,000 Pa·s; and
a grafting agent content ranging from 0.5 to 15.0 wt. % based on the total weight of the compatibilizer.

With preference, the grating agent is present in the compatibilizer at a content ranging from 0.8 to 5.0 wt. % based on the total weight of the compatibilizer; preferably from 0.9 to 4.0 wt. %; more preferably from 1.0 to 3.5 wt. %; even more preferably from 1.0 to 3.2 wt. % or from 1.0 to 3.0 wt. %, most preferably, from 1.1 to 2.8 wt. % or from 1.1 to 2.5 wt. %; and even most preferably from 1.2 to 2.2 wt. % or from 1.5 to 3.5 wt. %. It is understood that the grafting agent content represents the grafted content as determined by titration and does not include the unreacted grafting agent. In other words, the grafting agent content determination is performed after purification as described in the methods.

For example, the compatibilizer has a melt index MI₂ ranging from 25.0 to 420.0 g/10 min or from 30.0 to 400.0 g/10 min or from 40.0 to 400.0 g/10 min as determined according to ISO 1133-2011 at 190° C. under a load of 2.16 kg; preferably ranging from 40.0 to 380.0 g/10 min or from 40.0 to 350.0 g/10 min or from 45.0 to 300.0 g/10 min or from 45.0 to 280.0 g/10 min; even more preferably from 50.0 to 250.0 g/10 min or from 50.0 to 240.0 g/10 min, most preferably from 80.0 to 230.0 g/10 min; and even most preferably from 100.0 to 220.0 g/10 min, or from 130.0 to 210.0 g/10 min or from 150.0 to 200.0 g/10 min.

For example, the compatibilizer has a complex viscosity at 0.1 rad/sec at 190° C. of at most 15,000 Pa·s; preferably of at most 10,000 Pa·s; more preferably of at most 5,000 Pa·s; and most preferably of at most 3,000 Pa·s.

For example, the compatibilizer further has a complex viscosity ratio of at most 20 wherein the complex viscosity ratio is the ratio of the complex viscosity at a frequency of 0.1 rad/sec to the complex viscosity at a frequency of 100 rad/sec when measured at 190° C.; preferably of at most 18; more preferably of at most 15; even more preferably of at most 12; most preferably of at most 10 and even most preferably of at most 8.0.

With preference, the compatibilizer further has an Mz/Mw of at most 7.0 as determined by size exclusion chromatography; preferably at most 6.0; preferably at most 5.0.

For example, the compatibilizer further has an Mw/Mn ranging from 2.1 to 4.4 as determined by size exclusion chromatography; preferably from 2.2 to 4.0; more preferably from 2.3 to 3.5. For example, the compatibilizer further has a tan delta (G″/G′) at 0.1 rad at 190° C. above 2.5; preferably of at least 3.0; more preferably of at least 5.0 and even more preferably of at least 10.0.

In an embodiment, the step of providing a compatibilizer being a grafted polyethylene further comprises the sub-step of grafting a polyethylene-containing material to produce said compatibilizer.

For example, the sub-step of grafting of a polyethylene-containing material to produce the compatibilizer according to the disclosure comprises:
a) providing an extruder with one or more thermal regulation devices;
b) providing a polyethylene-containing material comprising at least 80 wt. % of polyethylene based on the total weight of the polyethylene-containing material;
c) providing a grafting agent in a content ranging from 0.8 to 10.0 wt. % based on the total weight of the polyethylene-containing material provided in step (b), wherein the grafting agent comprises at least one double bound per molecule;
d) extruding the polyethylene-containing material and the grafting agent to obtain a grafted polyethylene; wherein step (d) of extruding comprises a thermal treatment of the polyethylene-containing material at a maximum barrel temperature Ts of at least 315° C. in one or more hot zones of the extruder; and
e) recovering a grafted polyethylene being the compatibilizer;

The maximum barrel temperature Ts in the one or more hot zones of the extruder can be obtained in any way. For example, the maximum barrel temperature Ts of at least 315° C. in step (d) is obtained:
by self-heating of the material wherein the extruder is a twin screw extruder and the one or more hot zones have a total length equal to or greater than 6 D with D being the screw diameter, wherein the extrusion is performed with mechanical specific energy greater than or equal to 0.30 kWh/kg, wherein the screw profile comprises at least one hot zone with successive kneading blocks elements over a length of at least 4 D followed by a left-handed element with D being the screw diameter, wherein the thermal regulation devices, are set to initial imposed barrel temperatures ranging between 24° and 320° C. and are switched off when the barrel temperature in the zone spontaneously exceeds the imposed barrel temperature by at least 3° C. without the need of external heat application; or
by heating the material in an extruder selected from a single screw extruder or a twin-screw extruder, using the thermal regulation devices of the extruder to have a maximum barrel temperature Ts ranging from 315 to 430° C. in at least one hot zone of the extruder.

In an embodiment, the thermal treatment is performed by self-heating the material in a twin-screw extruder, and the screw profile comprises two or more hot zones wherein a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter.

In an embodiment, the thermal treatment is performed by self-heating the material in a twin-screw extruder and the successive kneading blocks elements of at least one hot zone of the extruder comprise disks with disks offset by 90 degrees and a disk width of at least 0.3 D wherein D is the screw diameter.

In an embodiment, one hot zone of the extruder is or comprises the melting zone of the extruder.

In a preferred embodiment, step (d) of extruding the polyethylene-containing material comprises a thermal treatment by self-heating of the material wherein the extrusion is performed in a twin-screw extruder and with mechanical specific energy greater than or equal to 0.30 kWh/kg, preferably greater than or equal to 0.35 kWh/kg; more preferably greater than or equal to 0.40 kWh/kg, even more preferably greater than or equal to 0.45 kWh/kg; most preferably greater than or equal to 0.50 kWh/kg and even most preferably greater than or equal to 0.60 kWh/kg.

For example, step (d) of extruding the polyethylene-containing material comprises a thermal treatment self-heating of the material or by heating of the material wherein the extrusion is performed at a maximum barrel temperature Ts ranging from 315 to 430° C. in at least one hot zone; preferably at a maximum barrel temperature ranging from 330 to 420° C.; more preferably at a maximum barrel temperature ranging from 340 to 410° C.; even more preferably at a maximum barrel temperature ranging from 360 to 400° C. and most preferably at a maximum barrel temperature ranging from 340 to 395° C.

For example, step (d) of extruding the polyethylene-containing material comprises a thermal treatment at a maximum barrel temperature of at least 315° C. in at least one hot zone; preferably at a temperature of at least 320° C.; more preferably at a temperature of at least 330° C.; even more preferably at a temperature of at least 340° C. and most preferably at a temperature of at least 350° C., or at a temperature of at least 360° C.

For example, step (d) of extruding the polyethylene-containing material comprises performing the extrusion with a residence time of less than 10 minutes such as ranging from 10 seconds to 10 minutes; preferably with a residence time ranging from 20 seconds to 5 minutes; more preferably with a residence time ranging from 10 to 180 seconds; even more preferably, from 10 to 120 seconds; most preferably, from 20 to 100 seconds; and even most preferably, from 30 to 80 seconds.

In an embodiment, the polyethylene-containing material is selected to have:
a high load melt index (HLMI R) of at least 1.0 g/10 min as determined according to ISO 1133-2011 at 190° C. under a load of 21.6 kg; and/or
a melt index (MI₂ R) of at most 3.0 g/10 min as determined according to ISO 1133-2011 at 190° C. under a load of 2.16 kg; and/or
a density of at least 0.910 g/cm³ as determined according to ISO 1183-1:2012 at 23° C.

For example, the polyethylene-containing material is selected to have:
a high load melt index (HLMI R) of at least 1.0 g/10 min as determined according to ISO 1133-2011 at 190° C. under a load of 21.6 kg, a melt index (MI₂ R) of at most 0.45 g/10 min as determined according to ISO 1133-2011 at 190° C. under a load of 2.16 kg and a density of at least 0.940 g/cm³ as determined according to ISO 1183-1:2012 at 23° C.; or
a melt index (MI₂ R) ranging from 0.8 to 1.5 g/10 min as determined according to ISO 1133-2011 at 190° C. under a load of 2.16 kg and a density ranging from 0.910 g/cm³ to 0.930 g/cm³ as determined according to ISO 1183-1:2012 at 23° C.

In an embodiment, the polyethylene-containing material further has:
an Mz/Mw of at least 4.0 as determined by size exclusion chromatography (SEC); and/or
a complex viscosity at 0.1 rad/sec at 190° C. of ranging from 20,000 to 80,000 Pa·s; and/or
an Mw/Mn ranging from 5.0 to 30.0 as determined by size exclusion chromatography; and/or
a complex viscosity ratio above 10 wherein the complex viscosity ratio is the ratio of the complex viscosity at a frequency of 0.1 rad/sec to the complex viscosity at a frequency of 100 rad/sec when measured at 190° C.; and/or
a tan delta (G″/G′ measured at 0.1 rad/s at 190° C.) ranging from 0.5 to 3.0; preferably, from 0.8 to 2.6.

For example, the polyethylene-containing material comprises at least 85 wt. % of polyethylene based on the total weight of the polyethylene-containing material; and/or is a recycled polyethylene-containing material.

In an embodiment, the grafting agent comprises or consists of one or more functional monomers selected from maleic anhydride (MAH), glycidyl methacrylate (GMA), methyl methacrylate (MMA), acrylic acid (AAc), butyl acrylate (BA) vinyl acetate (VA), diethyl maleate (DEM), acrylamide (AAm), acrylonitrile (CAN), and any mixture thereof. With preference, the grafting agent is or comprises maleic anhydride (MAH).

For example, the grafting agent is provided in a content ranging from 0.1 to 10.0 wt. % or from 0.8 to 8.0 wt. % or from 1.0 to 6.0 wt. % or from 1.5 to 4.0 wt. % or from 2.0 to 5.0 wt. % based on the total weight of the polyethylene-containing material provided on step (b).

The grating agent is present in the compatibilizer at a content ranging from 0.5 to 15.0 wt. % based on the total weight of the compatibilizer. Should the desired grafting level be not obtained the first time, the person skilled in the art may increase the maximum barrel temperature Ts in the one or more hot zones, the introduced grafting agent content, the residence time or the screw speed. For example, the person skilled in the art may adapt the design of the screw profile, as shown in the examples.

According to a second aspect, the present disclosure provides for a compatibilizer being a grafted polyethylene remarkable in that it comprises at least 70 wt. % of polyethylene based on the total weight of the compatibilizer, and has:
a melt index MI₂ ranging from 25 to 450.0 g/10 min as determined according to ISO 1133-2011 at 190° C. under a load of 2.16 kg;
an Mw/Mn ranging from 2.0 to 4.5 as determined by size exclusion chromatography;
a complex viscosity at 0.1 rad/sec at 190° C. of at most 15,000 Pa·s; and
a grafting agent content ranging from 0.5 to 15.0 wt. % based on the total weight of the compatibilizer;
   with preference, the melt index MI₂ ranging from 40 to 400 g/10 min or from 40 to 350 g/10 min (more preferably from 130 to 240.0 g/10 min) as determined according to ISO 1133-2011 at 190° C. under a load of 2.16 kg and/or the grafting agent content ranging from 1.1 to 2.5 wt. % based on the total weight of the compatibilizer or from 1.5 to 3.5 wt. %.

With preference, the grafting agent is or comprises maleic anhydride (MAH).

According to a second aspect, the present disclosure provides for the use of a compatibilizer according to the second aspect in a process to produce a polymer composition being the blend of a component A being one or more polyethylene resins and one or more polymers having a polar functional group.

### DESCRIPTION OF THE FIGURES

FIG. 1 is an example of a screw profile that can be used in the context of the disclosure.

FIG. 2 is another example of a screw profile that can be used in the context of the disclosure.

FIG. 3 is the Frequency sweeps for the experiments of screw profile “P1”. Complex viscosity as a function of the angular frequency (190° C., under nitrogen flow).

FIG. 4 MI₂ and grafted MA content as a function of the extrusion setpoint Temperature (maximum barrel temperature) for experiments realized at N=400 rpm with both screw profiles. Curves are drawn as guides for the eye.

FIG. 5 Grafted MA content as a function of the extrusion setpoint Temperature (maximum barrel temperature) for experiments realized at N=400 rpm with both screw profiles. Curves are drawn as guides for the eye.

FIG. 6 provides results for the Young Modulus (MPa) for the inventive and comparative compositions

FIG. 7 provides results for the Strain at Break (%) for the inventive and comparative compositions

FIG. 8 provides results for the Stress at Break (MPa) for the inventive and comparative compositions

FIG. 9 provides results for the Impact Strength (kJ/m²) for the inventive and comparative compositions

FIG. 10 provides results for the Young Modulus (MPa) for the inventive compositions using compatibilizers of different melt index

FIG. 11 provides results for the Strain at Break (%) for the inventive compositions using compatibilizers of different melt index

FIG. 12 provides results for the Stress at Break (MPa) for the inventive compositions using compatibilizers of different melt index

FIG. 13 provides results for the Impact Strength (kJ/m²) for the inventive compositions using compatibilizers of different melt index

### DETAILED DESCRIPTION

It is to be understood that this disclosure is not limited to particular processes or compositions described, as such processes or compositions may, of course, vary. It is also to be understood that the terminology used herein is not intended to be limiting since the scope of the present disclosure will be limited only by the appended claims.

When describing the polymers, uses and processes of the disclosure, the terms employed are to be construed by the following definitions, unless a context dictates otherwise. For the disclosure, the following definitions are given:

As used herein, the singular forms “a”, “an”, and “the” include both singular and plural referents unless the context dictates otherwise. By way of example, “a composition” means one composition or more than one composition.

The terms “comprising”, “comprises” and “comprised of as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 can include 1, 2, 3, 4, 5 when referring to, for example, a number of elements, and can also include 1.5, 2, 2.75 and 3.80, when referring to, for example, measurements). The recitation of endpoints also includes the endpoint values themselves (e.g., from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference. Indication of a standard method to determine a parameter implies referring to the standard in force at the priority date of the application, in case the year of the standard is not indicated.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure and form different embodiments, as would be understood by those in the art. For example, in the following claims and statements, any of the embodiments can be used in any combination.

Unless otherwise defined, all terms used in disclosing the disclosure, including technical and scientific terms, have the meaning as commonly understood by one of ordinary skill in the art to which this disclosure belongs. By means of further guidance, definitions for the terms used in the description are included to better appreciate the teaching of the present disclosure.

The terms “polyethylene” (PE) and “ethylene polymer” may be used synonymously. The term “polyethylene” encompasses ethylene homopolymer as well as ethylene copolymer resin which can be derived from ethylene and one or more comonomers selected from the group consisting of C₃-C₂₀ alpha-olefins, such as propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene.

The terms “polyethylene resin” or “ethylene homopolymer resin” or “ethylene copolymer resin” refer to polyethylene fluff or powder that is extruded, and/or melted and/or pelletized and can be produced through compounding and homogenizing of the polyethylene resin as taught herein, for instance, with mixing and/or extruder equipment. As used herein, the term “polyethylene” may be used as a shorthand for “polyethylene resin”. The terms “fluff” or “powder” refer to polyethylene material with the hard catalyst particle at the core of each grain and is defined as the polymer material after it exits the polymerization reactor (or the final polymerization reactor in the case of multiple reactors connected in series).

The terms “Post-Consumer Resin”, which may be abbreviated as “PCR”, is used to denote the components of domestic waste, household waste or end of life vehicle waste. In other words, the PCRs are made of recycled products from waste created by consumers. The terms “Post-Industrial Resin”, which may be abbreviated as “PIR”, is used to denote the waste components from pre-consumer resins during packaging processes. In other words, the PIRs are made of recycled products created from scrap by manufacturers.

The term “recycled polyethylene composition” or “recycled polyethylene-containing material” contrasts with the term “virgin polyethylene composition” “virgin polyethylene-containing material”, the term “virgin” is used to denote a polyethylene composition or material directly obtained from a polyethylene-containing polymerization plant. The terms “directly obtained” is meant to include that the polyethylene composition may optionally be passed through a pelletization step or an additivation step or both.

The present disclosure provides for a process to produce a polymer composition obtained by such a process comprising one or more polyethylene resins (i.e., a component A) and one or more materials selected from materials having a polar functional group, inorganic polar particles, polymers having a polar functional group, HD silica, fumed silica, carbon-containing particles, carbon fibres, glass fibres, natural fibres, and any mixture thereof (i.e., a component B).

According to the disclosure, the process to produce a polymer composition is comprising the steps of:
providing from 10 to 90 wt. % of a component A based on the total weight of the polymer composition; wherein the component A is one or more polyethylene resins selected from a high-density polyethylene resin, a medium-density polyethylene resin, a low-density polyethylene resin, a linear low-density polyethylene resin and any mixture thereof;
providing from 90 to 10 wt. % of a component B based on the total weight of the polymer composition; wherein the component B is one or more materials selected from materials having a polar functional group, inorganic polar particles, polymers having a polar functional group, HD silica, fumed silica, carbon-containing particles, carbon fibres, glass fibres, natural fibres, and any mixture thereof;
providing from 0.5 to 20 wt. % of a compatibilizer based on the total weight of the polymer composition; wherein the compatibilizer is a grafted polyethylene, and
melt blending the component A, the component B and the compatibilizer to obtain a polymer composition;
   and is remarkable in that the compatibilizer is comprising at least 70 wt. % of polyethylene based on the total weight of the compatibilizer, and has:
a melt index MI₂ ranging from 25 to 450.0 g/10 min as determined according to ISO 1133-2011 at 190° C. under a load of 2.16 kg;
an Mw/Mn ranging from 2.0 to 4.5 as determined by size exclusion chromatography;
a complex viscosity at 0.1 rad/sec at 190° C. of at most 15,000 Pa·s; and
a grafting agent content ranging from 0.5 to 15.0 wt. % based on the total weight of the compatibilizer.

In an embodiment, the step of providing a compatibilizer being a grafted polyethylene further comprises the sub-step of grafting a polyethylene-containing material to produce said compatibilizer.

The component A being one or more polyethylene resins is provided at a content ranging from 10 to 90 wt. % based on the total weight of the polymer composition; preferably, ranging from 20 to 80 wt. %; more preferably ranging from 30 to 70 wt. %; even more preferably ranging from 40 to 60 wt. %, and most preferably ranging from 45 to 55 wt. %.

The component B is provided at a content ranging from 90 to 10 wt. % based on the total weight of the polymer composition; preferably, ranging from 80 to 20 wt. %; more preferably ranging from 70 to 30 wt. %; even more preferably ranging from 60 to 40 wt. %; and most preferably ranging from 55 to 45 wt. %.

The compatibilizer is provided at a content ranging from 0.5 to 20 wt. % based on the total weight of the polymer composition; preferably, ranging from 0.6 to 15 wt. %; more preferably ranging from 0.7 to 10 wt. %; even more preferably ranging from 0.8 to 5 wt. %, and most preferably ranging from 0.9 to 3 wt. %.

For example, the process to produce a polymer composition comprises:
providing from 40 to 60 wt. % of a component A based on the total weight of the polymer composition;
providing from 60 to 40 wt. % of a component B based on the total weight of the polymer composition; and
providing from 0.8 to 5 wt. % of the compatibilizer based on the total weight of the polymer composition.
   The Component A being One or More Polyethylene

According to the present disclosure, the one or more polyethylene resins of the component A are selected from a high-density polyethylene resin, a medium-density polyethylene resin, a low-density polyethylene resin, a linear low-density polyethylene resin and any mixture thereof. With preference, the one or more polyethylene resins of the component A are selected from a high-density polyethylene resin, a linear low-density polyethylene resin and any mixture thereof.

For example, the one or more polyethylene resins of the component A have a density of at least 0.910 g/cm³ as determined according to ISO 1183-1:2012 at 23° C. and/or a density of at most 0.965 g/cm³ as determined according to ISO 1183-1:2012 at 23° C.

In an embodiment, the one or more polyethylene resins of the component A have a density of at least 0.910 g/cm³ as determined according to ISO 1183-1:2012 at 23° C.; preferably, at least preferably, at least 0.912 g/cm³; more preferably, at least 0.915 g/cm³; even more preferably of at least 0.918 g/cm³; and most preferably, of at least 0.920 g/cm³.

For example, the one or more polyethylene resins of the component A are or comprise one or more high-density polyethylene resins and have a density of at most 0.945 g/cm³ as determined according to ISO 1183-1:2012 at 23° C.; preferably, of at most 0.940 g/cm³; and more preferably, of at most 0.938 g/cm³.

For example, the one or more polyethylene resins are or comprise one or more high-density polyethylene resins and have a density ranging from 0.910 g/cm³ to 0.945 g/cm³ as determined according to ISO 1183-1:2012 at 23° C.; preferably, ranging from 0.912 g/cm³ to 0.940 g/cm³; more preferably, ranging from 0.915 g/cm³ to 0.938 g/cm³; and even more preferably, ranging from 0.918 g/cm³ to 0.935 g/cm³.

For example, the one or more polyethylene resins are or comprise one or more linear low-density polyethylene resins. For example, the composition is a composition for film applications and the one or more polyethylene resins of the component A are polyethylene suitable for film applications.

In another embodiment, the one or more polyethylene resins of the component A are or comprise one or more high-density polyethylene resins and have a density of at least 0.940 g/cm³ as determined according to ISO 1183-1:2012 at 23° C.; preferably, at least preferably, at least 0.945 g/cm³; more preferably, at least 0.948 g/cm³; even more preferably of at least 0.950 g/cm³; and most preferably, of at least 0.951 g/cm³.

For example, the one or more polyethylene resins of the component A are or comprise one or more high-density polyethylene resins and have a density of at most 0.965 g/cm³ as determined according to ISO 1183-1:2012 at 23° C.; preferably, of at most 0.962 g/cm³; and more preferably, of at most 0.960 g/cm³.

For example, the one or more polyethylene resins are or comprise one or more high-density polyethylene resins and have a density ranging from 0.940 g/cm³ to 0.965 g/cm³ as determined according to ISO 1183-1:2012 at 23° C.; preferably, ranging from 0.942 g/cm³ to 0.964 g/cm³; more preferably, ranging from 0.945 g/cm³ to 0.962 g/cm³; and even more preferably, ranging from 0.948 g/cm³ to 0.960 g/cm³.

For example, the composition is a composition for blow-molding applications and the one or more polyethylene resins of the component A are polyethylene suitable for blow-molding applications.

In an embodiment, the one or more polyethylene resins have a high load melt index (HLMI) of at least 1.0 g/10 min as determined according to ISO 1133-2011 at 190° C. under a load of 21.6 kg; preferably at least 5 g/10 min; more preferably at least 10 g/10 min; even more preferably at least 15 g/10 min or at least 20 g/10 min.

For example, the one or more polyethylene resins have a melt index (MI₂) of at least 0.10 g/10 min as determined according to ISO 1133-2011 at 190° C. under a load of 2.16 kg; preferably at least 0.15 g/10 min; more preferably at least 0.18 g/10 min; even more preferably at least 0.20 g/10 min, and most preferably at least 0.23 g/10 min.

For example, the one or more polyethylene resins have a melt index (MI₂) of at most 20.0 g/10 min as determined according to ISO 1133-2011 at 190° C. under a load of 2.16 kg; preferably at most 15.0 g/10 min; more preferably at most 10.0 g/10 min; even more preferably at most 5.0 g/10 min; or at most 3.0 g/10 min; and most preferably at most 2.8 g/10 min; or at most 2.5 g/10 min; or at most 2.2 g/10 min; or at most 2.0 g/10 min; or at most 1.8 g/10 min, or at most 1.6 g/10 min; or at most 1.5 g/10 min; or at most 1.2 g/10 min, or at most 1.0 g/10 min; or at most 0.9 g/10 min.

### The Component B

The component B is one or more materials selected from materials having a polar functional group, inorganic polar particles, polymers having a polar functional group, HD silica, fumed silica, carbon-containing particles, carbon fibres, glass fibres, natural fibres, and any mixture thereof.

For example, the polar functional group is at least one selected from the group consisting of a carboxyl group, a hydroxyl group, an epoxy group, an amino group, an amide group, a silyl group, an acetylacetonato group, and a mercapto group. With preference, the polar functional group is at least one selected from the group consisting of a carboxyl group, a hydroxyl group, an amino group, and an amide group.

For example, the one or more polymers having a polar functional group are selected from polyamide, ethylene vinyl alcohol, polyester, cellulose derivative with a hydroxyl group, and any mixture thereof; preferably, selected from polyamide and/or ethylene vinyl alcohol.

In a preferred embodiment the one or more polymers having a polar functional group are or comprise one or more polyamides.

The polyamide can be selected from aliphatic, semi-aromatic or aromatic polyamides, which can have a crystalline, semi-crystalline or amorphous structure.

The polyamide can further be a virgin polyamide or a recycled material comprising polyamide.

Examples of polyamides include polyhexamethylene-adipamide, polyhexamethylene azelaamide, polyhexamethylene sebacamide, and polyhexamethylene dodecanoamide, and polyamides produced by ring opening of lactams, i.e., polycaprolactam, polylauric lactam, poly-11-aminoundecanoic acid, bisϕparaaminocyclohexyl) methane dodecanoamide.

With preference, the one or more polyamides are selected from PA-6; PA-6,6; PA-6,9; PA-6,10; PA-6,12; PA-11; PA-4,6 and PA-66/6 copolymer. With preference, the one or more polyamides are or comprise PA-6.

### The Compatibilizer and the Production of Said Compatibilizer

According to the invention, the compatibilizer comprises at least 70 wt. % of polyethylene based on the total weight of the compatibilizer and has:
a melt index MI₂ ranging from 25 to 450.0 g/10 min as determined according to ISO 1133-2011 at 190° C. under a load of 2.16 kg;
an Mw/Mn ranging from 2.0 to 4.5 as determined by size exclusion chromatography;
a complex viscosity at 0.1 rad/sec at 190° C. of at most 15,000 Pa·s; and
a grafting agent content ranging from 0.5 to 15.0 wt. % based on the total weight of the compatibilizer.

The sub-step of production of the compatibilizer is preferably performed without peroxides and/or without ultrasounds.

For example, the sub-step of grafting of a polyethylene-containing material to produce the compatibilizer according to the disclosure comprises:
a) providing an extruder with one or more thermal regulation devices;
b) providing a polyethylene-containing material comprising at least 80 wt. % of polyethylene based on the total weight of the polyethylene-containing material;
c) providing a grafting agent in a content ranging from 0.8 to 10.0 wt. % based on the total weight of the polyethylene-containing material provided in step (b), wherein the grafting agent comprises at least one double bound per molecule;
d) extruding the polyethylene-containing material and the grafting agent to obtain a grafted polyethylene; wherein step (d) of extruding comprises a thermal treatment of the polyethylene-containing material at a maximum barrel temperature Ts of at least 315° C. in one or more hot zones of the extruder; and
e) recovering a grafted polyethylene being the compatibilizer;

For example, the maximum barrel temperature Ts of at least 315° C. in step (d) is obtained:
by self-heating of the material wherein the extruder is a twin screw extruder and the one or more hot zones have a total length equal to or greater than 6 D with D being the screw diameter, wherein the extrusion is performed with mechanical specific energy greater than or equal to 0.30 kWh/kg, wherein the screw profile comprises at least one hot zone with successive kneading blocks elements over a length of at least 4 D followed by a left-handed element with D being the screw diameter, wherein the thermal regulation devices, are set to initial imposed barrel temperatures ranging between 24° and 320° C., and are switched off when the barrel temperature in the zone spontaneously exceeds the imposed barrel temperature by at least 3° C. without the need of external heat application; or
by heating the material in an extruder selected from a single screw extruder or a twin screw extruder, using the thermal regulation devices of the extruder to have a maximum barrel temperature Ts ranging from 315 to 430° C. in at least one hot zone of the extruder.

The sub-step of grafting of a polyethylene-containing material involves increasing the melt index of the said polyethylene-containing material to produce a compatibilizer (i.e., a grafted polyethylene) with a melt index that is increased by a factor k of more than 2.0; preferably by a factor k of at least 3.0; preferably by a factor k of at least 5.0; preferably by a factor k of at least 6.0; preferably by a factor k of at least 8.0; preferably by a factor k of at least 10.0; preferably by a factor k of at least 15.0; preferably by a factor k of at least 20.0; preferably by a factor k of at least 40.0.

So that the ratio of the melt index of the compatibilizer (MI₂ T) to the melt index of the polyethylene-containing material (MI₂ R) is more than 2.0; preferably of at least 3.0, preferably by at least 5.0; preferably at least 6.0; preferably at least 8.0; preferably at least 10.0; preferably at least 15.0; preferably at least 20.0; preferably at least 40.0.

The treatment of the polyethylene-containing material to obtain a compatibilizer is performed by extrusion wherein step (d) of extruding comprises a thermal treatment of the polyethylene-containing material at a maximum barrel temperature Ts of at least 315° C. in one or more hot zones of the extruder; preferably wherein extrusion is performed with a residence time of less than 10 min.

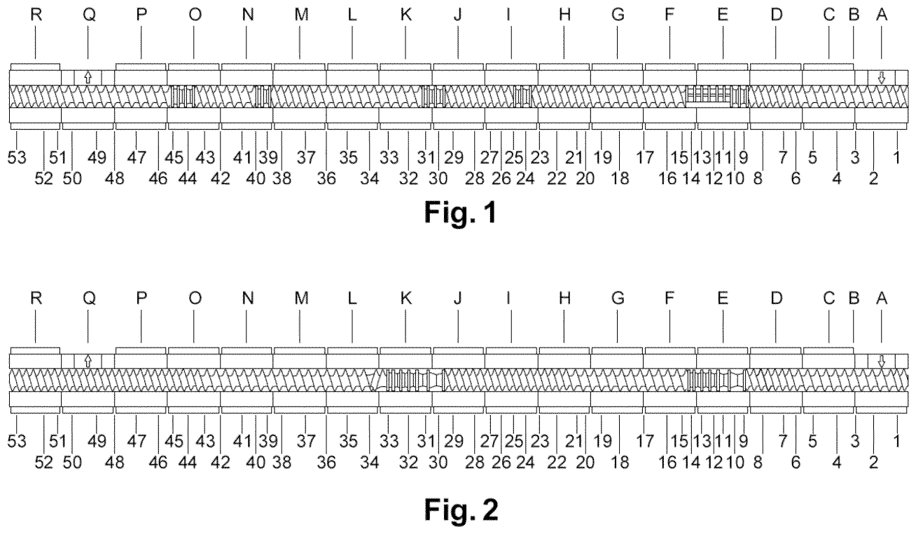

The extruder can be a single-screw extruder or a twin-screw extruder. In a preferred embodiment, the extruder is a twin-screw extruder. The extruder can be a single screw extruder or a twin-screw extruder provided with a standard configuration for the screw profile (for example when the process comprises a thermal treatment by heating the material using the thermal regulation devices) or is a twin-screw extruder provided with a screw profile that shows an aggressive design, as shown in FIG. 1, to impart high mechanical energy to the polyethylene-containing material (for example when the process comprises a thermal treatment by self-heating) or by heating the material using the thermal regulation devices.

As known to the person skilled in the art, thermal regulation devices can be used as heating means to impart thermal energy to the polyethylene-containing material in the extruder, in addition to the thermal energy already generated by the mixing.

Extrusion mixing varies with the type of screw and screw profile and is capable of significant generation of mechanical energy, such as shear energy and/or elongation energy. Therefore, energy is introduced into the extrusion process in terms of mechanical energy and thermal energy. Heating and/or cooling of the barrels can be achieved, for example, electrically, by steam, or by the circulation of thermally controlled liquids such as oil or water.

The extruder screw comprises a screw main body, that is composed of cylindrical elements and an axis of rotation supporting the elements. The axis of rotation extends straight from its basal end to its tip. In a state in which the extruder screw is rotatably inserted in the cylinder of the barrel, the basal end of the extruder screw is positioned on one end side of the barrel, on which the supply port is provided, and the tip of the extruder screw is positioned on the other end side of the barrel, on which the discharge port is provided.

Screw extruders have a modular system that allows different screw elements to be drawn into the central shaft to build a defined screw profile. The extruder screw may comprise one or more elements selected from conveying elements, kneading elements, right-handed (normal) screw elements, left-handed (inverse) screw elements and any combination thereof. The elements are arranged in a defined order from the basal end to the tips of the extruder screw and this order, as well as the type and number of elements involved, defines the screw profile. Extruders and screw elements are commercially available for example at Leistritz.

In an embodiment of the disclosure, the treatment of the polyethylene-containing material is handled by mechanical energy.

When high mechanical energy is requested, the extruder provided has a specific screw profile that is built to be “aggressive”, meaning that high mechanical energy will be imparted to the polyethylene-containing material. High mechanical energy will result in an increase in the temperature in the extruder as known to the person skilled in the art so that the thermal treatment is performed by self-heating of the material. Self-heating of the material is achieved from viscous dissipation in a twin-screw extruder.

In such an embodiment, the twin-screw extruder is selected to comprise one or more hot zones, preferably being filled mixing zones, wherein the total length of the one or more hot zones is equal to or greater than 6 D with D being the screw diameter.

It is understood that in case the screw profile is selected to comprise a single hot zone, then the total length of the said hot zone is equal to or greater than 6 D with D being the screw diameter. In such a case, the hot zone is also the melting zone of the twin-screw extruder.

In case, the screw profile comprises two or more hot zones, then a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter. For example, the twin-screw extruder comprises two filled mixing zones wherein each of the filled mixing zones has a length equal to or greater than 4 D with D being the screw diameter. Preferably the first hot zone is or comprises the melting zone of the extruder.

Various mixing elements could be considered in the one or more hot zones but the most preferred ones do not drive any forward conveying (dispersive kneading blocks elements with disks offset by 90 degrees). Other disk offset angles could be considered (for example 30 degrees, 45 degrees, or 60 degrees) but 90 degrees is preferred. The preferred minimum width of the disk is 0.3 D.

Thus, preferably, the successive kneading block elements of at least one hot zone comprise disks with disks offset by 90 degrees and a disk width of at least 0.3 D wherein D is the screw diameter.

For example, the twin-screw extruder comprises more than two filled mixing zones wherein the total length of filled mixing zones is equal to or greater than 8 D with D being the screw diameter.

For example, the strong melting zone of the twin-screw extruder is made of successive mixing elements over a length of 4 D, with D being the screw diameter, followed by a left-handed element; preferably a full-flight left-handed element.

In a preferred embodiment, the thermal regulation devices of the twin-screw extruder allow cooling of the barrels and the process comprises switching off the thermal regulation devices when the barrel temperature in the zone spontaneously exceeds the imposed barrel temperature by at least 1° C. without the need of external heat application; preferably, by at least 2° C., preferably, by at least 3° C.; more preferably by at least 5° C.; even more preferably, by at least 8° C.; and most preferably, by at least 10° C.

Indeed, when starting extrusion, thermal regulation devices will be switched on, in particular in the melting zone to allow the material to melt. Then, when the polymer is self-heating the thermal regulation devices are switched off to allow the increase of the temperature inside the extruder.

In a preferred embodiment, step (d) of extruding the polyethylene-containing material comprises performing the extrusion with mechanical specific energy greater than or equal to 0.30 kWh/kg, preferably greater than or equal to 0.35 kWh/kg; more preferably greater than or equal to 0.40 kWh/kg; even more preferably greater than or equal to 0.45 kWh/kg; most preferably greater than or equal to 0.50 kWh/kg and even most preferably greater than or equal to 0.60 kWh/kg.

High rotation screw speeds are preferred, but the precise value of a high rotation screw speed is “extruder diameter” dependent. For example, when considering a diameter D of 18 mm twin-screw extruder, high rotational screw speed is considered to be higher than 500 rpm, preferably higher than 800 rpm. For example, when considering a diameter D=58 mm twin-screw extruder, high rotational screw speed is considered to be higher than 250 rpm, preferably higher than 350 rpm.

Non-limiting examples of suitable extruder screws with specific screw profiles are illustrated in FIGS. 1 and 2.

When the thermal treatment is performed by heating the material in an extruder selected from a single screw extruder or a twin-screw extruder, the extruder provided can show either an extruder screw with a standard screw profile or with a specific screw profile (i.e., for enhanced self-heating).

In such an embodiment, step (d) is performed at a maximum barrel temperature of at least 315° C.; preferably at least 320° C.; more preferably at least 330° C.; even more preferably at least 340° C.

Whether the thermal treatment is performed by heating or self-heating of the material, the thermal treatment of material in step (d) is preferably performed at a maximum barrel temperature ranging from 315 to 430° C.; preferably, ranging from 320° C. to 420° C.; more preferably ranging from 330° C. to 410° C.; even more preferably, ranging from 340° C. to 400° C. and most preferably, ranging from 350° C. to 395° C. The maximum barrel temperature Ts is the highest temperature amongst the imposed or measured temperatures along the extruder.

For example, step (d) of extruding the polyethylene-containing material comprises a thermal treatment at a maximum barrel temperature of at least 315° C. in one or more hot zones of the extruder; preferably at a maximum barrel temperature of at least 320° C.; more preferably at a maximum barrel temperature of at least 330° C.; even more preferably at a maximum barrel temperature ranging from 315 to 430° C. and most preferably at a maximum barrel temperature ranging from 320 to 420° C., or at a maximum barrel temperature ranging from 330 to 410° C.

For example, step (d) of extruding the polyethylene-containing material comprises a thermal treatment at a maximum barrel temperature ranging from 315 to 430° C. in one or more hot zones of the extruder; preferably at a maximum barrel temperature ranging from 320 to 420° C.; more preferably at a maximum barrel temperature ranging from 330 to 410° C.; even more preferably at a maximum barrel temperature ranging from 340 to 400° C. and most preferably at a maximum barrel temperature ranging from 350 to 395° C., or at a maximum barrel temperature ranging from 320 to 390° C.

The extrusion conditions may be adapted by the person skilled in the art to impart sufficient energy to obtain a compatibilizer with a melt index (MI₂ T) in the targeted range.

Screw speed can be adapted in function of the targeted maximum barrel temperature Ts and of the capacity of the extruder. Higher screw speed allows for a higher increase in the polymer temperature. For example, the screw speed ranges from 100 to 1200 rpm; preferably from 110 rpm to 1200 rpm; more preferably from 150 rpm to 1100 rpm; even more preferably from 200 rpm to 1000 rpm; most preferably from 300 rpm to 900 rpm; and even most preferably from 320 to 800 rpm or from 350 to 1200 rpm.

In an 18 mm screw diameter twin-screw extruder, the preferred screw speed is higher than 500 rpm; in a 58 mm screw diameter twin-screw extruder, the preferred screw speed is higher than 250 rpm.

For example, step (d) of extruding the polyethylene-containing material comprises performing the extrusion with a residence time of less than 10 minutes, such as ranging from 10 seconds to 10 minutes; preferably with a residence time ranging from 20 seconds to 5 minutes; more preferably with a residence time ranging from 10 to 180 seconds or from 10 to 120 seconds or from 20 to 100 seconds or from 30 to 80 seconds.

For example, the extruder comprises one or more venting parts at the end of the extruder (before the die). Such venting parts, connected to a vacuum pump, allow removing at least a part of the unreacted grafting agent.

For example, the extruder is selected to have a surface treatment. For example, one or more elements of the extruder are made of CrVNb microalloyed steel. Extruders with surface treatments are commercially available from Leistritz.

The process according to the disclosure comprises step (b) of providing a polyethylene-containing material comprising at least 80 wt. % of polyethylene based on the total weight of the polyethylene-containing material.

The polyethylene-containing material can be a virgin polyethylene-containing material, a recycled polyethylene-containing material or a mixture of virgin and recycled polyethylene-containing materials. In some embodiments, the polyethylene-containing material is a recycled polyethylene-containing material. As used herein, the terms “recycled polyethylene composition” encompasses both Post-Consumer Resins (PCR) and Post-Industrial Resins (PIR).

Suitable polyethylene includes but is not limited to homopolymer of ethylene, copolymer of ethylene and a higher alpha-olefin comonomer. Thus, preferably, the polyethylene in the polyethylene-containing material is one or more polyethylene homopolymers, one or more polyethylene copolymers, and any mixture thereof.

The term “copolymer” refers to a polymer, which is made by linking two different types of monomers in the same polymer chain. Preferred comonomers are alpha-olefins having from 3 to 20 carbon atoms or from 3 to 10 carbon atoms. More preferred comonomers are selected from the group comprising propylene, butene-1, pentene-1, hexene-1, heptene-1, octene-1, nonene-1, decene-1 and any mixture thereof. Even more preferred comonomers are selected from the group comprising butene-1, hexene-1, octene-1 and any mixture thereof. The most preferred comonomer is hexene-1.

The term “homopolymer” refers to a polymer that is made by linking only one monomer in the absence of comonomers. Ethylene homopolymers are therefore essentially without any comonomer. By “essentially without” it is meant that no comonomer is intentionally added during the production of the polyethylene, but can nevertheless be present in up to 0.2 wt. %, preferably in up to 0.1 wt. % and most preferably in up to 0.05 wt. %, relative to the total weight of the polyethylene.

The polyethylene-containing material is selected to comprise at least 50 wt. % of polyethylene based on the total weight of the polyethylene-containing material. With preference, the polyethylene-containing material is selected to comprise at least 55 wt. % of polyethylene based on the total weight of the polyethylene-containing material; preferably, at least 60 wt. %; preferably, at least 70 wt. %; preferably, at least 80 wt. %; preferably, at least 90 wt. %; preferably, at least 95 wt. %. In an embodiment, the polyethylene-containing material is virgin material and consists of polyethylene (i.e. comprises 100 wt. % of polyethylene).

In an embodiment, the polyethylene-containing material is a recycled polyethylene-containing material. Recycled polyethylene-containing material may contain one or more polymers different from polyethylene.

In an embodiment, and in particular wherein the polyethylene-containing material is a recycled polyethylene-containing material; the polyethylene-containing material comprises at least one polymer different from polyethylene in a content ranging from 0 to 80 wt. % of the based on the total weight of the polyethylene-containing material wherein at least one polymer different from polyethylene is selected from polypropylene (PP), polyacrylate, polyethylene terephthalate (PET), polystyrene (PS), polylactic acid (PLA).

For example; the polyethylene-containing material comprises at least one polymer different from polyethylene in a content ranging from 0 to 50 wt. % of the based on the total weight of the polyethylene-containing material wherein at least one polymer different from polyethylene is selected from polypropylene (PP), polyacrylate, polyethylene terephthalate (PET), polystyrene (PS), polylactic acid (PLA), and any mixture thereof.

With preference, the polyethylene-containing material comprises at least one polymer different from polyethylene in a content ranging from 0 to 40 wt. % of the based on the total weight of the polyethylene-containing material; preferably from 0.1 to 20 wt. %; more preferably from 0.2 to 10 wt. %; and even more preferably from 0.5 to 5 wt. %.

For example, PCR polyethylene classically contains a small part of polypropylene (such as less than 5 wt. %).

In an embodiment, the polyethylene-containing material, or the polyethylene in the polyethylene-containing material, has a high load melt index (HLMI R) of at least 1.0 g/10 min as determined according to ISO 1133-2011 at 190° C. under a load of 21.6 kg; preferably at least 1.2 g/10 min; more preferably at least 1.5 g10 min.

In an embodiment, the polyethylene-containing material, or the polyethylene in the polyethylene-containing material, has a melt index (MI₂ R) of at least 0.10 g/10 min as determined according to ISO 1133-2011 at 190° C. under a load of 2.16 kg; preferably at least 0.15 g/10 min; more preferably at least 0.2 g/10 min; even more preferably at least 0.5 g/10 min. most preferably at least 0.8 g/10 min and even most preferably at least 0.9 g/10 min, or at least 1.0 g/10 min.

For example, the polyethylene-containing material is selected to have a melt index ranging from a high load melt index (HLMI R) as determined according to ISO 1133-2011 at 190° C. under a load of 21.6 kg of at least 1.0 g/10 min to a melt index (MI₂ R) of at most 3.0 g/10 min as determined according to ISO 1133-2011 at 190° C. under a load of 2.16 kg.

In an embodiment the polyethylene-containing material, or the polyethylene in the polyethylene-containing material, has a melt index (MI₂ R) of at most 3.0 g/10 min as determined according to ISO 1133-2011 at 190° C. under a load of 2.16 kg; preferably at most 2.8 g/10 min; more preferably at most 2.5 g/10 min; even more preferably at most 2.2 g/10 min. most preferably at most 2.0 g/10 min and even most preferably at most 1.8 g/10 min, or at most 1.6 g/10 min.

For example, the polyethylene-containing material, or the polyethylene in the polyethylene-containing material, has a density of at least 0.910 g/cm³ as determined according to ISO 1183-1:2012 at 23° C.

In an embodiment, the polyethylene-containing material is selected to have a high load melt index (HLMI R) of at least 1.0 g/10 min as determined according to ISO 1133-2011 at 190° C. under a load of 21.6 kg, a melt index (MI₂ R) of at most 0.45 g/10 min as determined according to ISO 1133-2011 at 190° C. under a load of 2.16 kg and a density of at least 0.940 g/cm³ as determined according to ISO 1183-1:2012 at 23° C.

For example, the polyethylene-containing material, or the polyethylene in the polyethylene-containing material, has a density of at least 0.940 g/cm³ as determined according to ISO 1183-1:2012 at 23° C.; preferably, at least preferably, at least 0.945 g/cm³; more preferably, at least 0.948 g/cm³; even more preferably of at least 0.950 g/cm³; and most preferably, of at least 0.951 g/cm³.

For example, the polyethylene-containing material, or the polyethylene in the polyethylene-containing material, has a density of at most 0.965 g/cm³ as determined according to ISO 1183-1:2012 at 23° C.; preferably, of at most 0.962 g/cm³; and more preferably, of at most 0.960 g/cm³.

For example, the polyethylene-containing material, or the polyethylene in the polyethylene-containing material, has a density ranging from 0.940 g/cm³ to 0.965 g/cm³ as determined according to ISO 1183-1:2012 at 23° C.; preferably, ranging from 0.942 g/cm³ to 0.964 g/cm³; more preferably, ranging from 0.945 g/cm³ to 0.962 g/cm³; and even more preferably, ranging from 0.948 g/cm³ to 0.960 g/cm³.

For example, the polyethylene-containing material, or the polyethylene in the polyethylene-containing material, has a melt index ranging from a high load melt index (HLMI R) as determined according to ISO 1133-2011 at 190° C. under a load of 21.6 kg of at least 1.0 g/10 min to a melt index (MI₂ R) of at most 0.45 g/10 min as determined according to ISO 1133-2011 at 190° C. under a load of 2.16 kg.

For example, the polyethylene-containing material, or the polyethylene in the polyethylene-containing material, has a high load melt index (HLMI R) of at least 1.0 g/10 min as determined according to ISO 1133-2011 at 190° C. under a load of 21.6 kg; preferably at least 1.2 g/10 min; more preferably at least 1.5 g/10 min.

For example, the polyethylene-containing material, or the polyethylene in the polyethylene-containing material, has a melt index (MI₂ R) of at most 0.45 g/10 min as determined according to ISO 1133-2005 at 190° C. under a load of 2.16 kg; preferably, at most 0.42 g/10 min; more preferably at most 0.40 g/10 min; even more preferably ranging at most 0.35 g/10 min.

In another embodiment, the polyethylene-containing material is selected to have a melt index (MI₂ R) ranging from 0.8 to 1.5 g/10 min as determined according to ISO 1133-2011 at 190° C. under a load of 2.16 kg and a density of ranging from 0.910 g/cm³ to 0.930 g/cm³ as determined according to ISO 1183-1:2012 at 23° C.

With preference, the polyethylene-containing material, or the polyethylene in the polyethylene-containing material, has a density of at least 0.910 g/cm³ as determined according to ISO 1183-1:2012 at 23° C.; preferably, at least preferably, at least 0.912 g/cm³; more preferably, at least 0.915 g/cm³; and even more preferably of at least 0.916 g/cm³.

For example, the polyethylene-containing material, or the polyethylene in the polyethylene-containing material, has a density of at most 0.930 g/cm³ as determined according to ISO 1183-1:2012 at 23° C.; preferably, of at most 0.928 g/cm³; and more preferably, of at most 0.925 g/cm³.

For example, the polyethylene-containing material, or the polyethylene in the polyethylene-containing material, has a density ranging from 0.910 g/cm³ to 0.930 g/cm³ as determined according to ISO 1183-1:2012 at 23° C.; preferably, ranging from 0.912 g/cm³ to 0.928 g/cm³; more preferably, ranging from 0.915 g/cm³ to 0.925 g/cm³; and even more preferably, ranging from 0.916 g/cm³ to 0.925 g/cm³.

For example, the polyethylene-containing material, or the polyethylene in the polyethylene-containing material, has a melt index (MI₂ R) ranging from 0.8 to 1.5 g/10 min as determined according to ISO 1133-2011 at 190° C. under a load of 2.16 kg; preferably, ranging from 0.8 to 1.4 g/10 min; more preferably ranging from 0.9 to 1.3 g/10 min; even more preferably ranging from 1.0 to 1.2 g/10 min.

In some embodiments, the polyethylene-containing material or the polyethylene in the polyethylene-containing material has an Mz/Mw of at least 4.0 as determined by gel permeation chromatography; preferably, ranging from 4.0 to 50.0; preferably, from 5.0 to 25.0; preferably, from 7.0 to 15.0.

In some embodiments, the polyethylene-containing material or the polyethylene in the polyethylene-containing material, has a complex viscosity at 0.1 rad/sec at 190° C. of ranging from 20,000 to 80,000 Pa·s; preferably, ranging from 22,000 to 70,000 Pa·s; more preferably, ranging from 25,000 to 60,000 Pa·s; and even more preferably, ranging from 30,000 to 50,000 Pa·s.

In some embodiments, the polyethylene-containing material or the polyethylene in the polyethylene-containing material, has an Mw/Mn ranging from 5.0 to 30.0 as determined by gel permeation chromatography; preferably ranging from 6.0 to 20.0; preferably ranging from 7.0 to 15.0.

In some embodiments, the polyethylene-containing material or the polyethylene in the polyethylene-containing material, has a complex viscosity ratio above 10; preferably, a complex viscosity ratio of at least 11; more preferably, a complex viscosity ratio of at least 12.

### The Grafting Agent and the Step (c) of Providing a Grafting Agent

The process according to the disclosure comprises a step (c) of providing a grafting agent comprising at least one double bound per molecule. For example, the grafting agent comprises at least one vinyl group per molecule.

For example, the grafting agent comprises or consists of one or more functional monomers selected from maleic anhydride (MAH), glycidyl methacrylate (GMA), methyl methacrylate (MMA), acrylic acid (AAc), butyl acrylate (BA) vinyl acetate (VA), diethyl maleate (DEM), acrylamide (AAm), acrylonitrile (CAN), and any mixture thereof. With preference, the grafting agent is or comprises maleic anhydride (MAH).

The grafting agent is provided in a content ranging from 0.1 to 10.0 wt. % or from 0.5 to 10.0 wt. % or from 0.8 to 10.0 wt. % based on the total weight of the polyethylene-containing material; preferably, from 0.9 to 8.0 wt. %; more preferably, from 1.0 to 6.0 wt. %; even more preferably, from 1.1 to 5.5 wt. %; most preferably, from 1.2 to 5.0 wt. %; even most preferably, from 1.3 to 4.5 wt. %; or from 1.5 to 4.0 wt. %; or from 2.0 to 5.0 wt. %.

For example, the grafting agent is provided in a content of at least 0.1 wt. % or at least 0.2 wt. % or at least 0.5 wt. % or at least 0.7 wt. % or at least 0.8 wt. % or at least 0.9 wt. % based on the total weight of the polyethylene-containing material; preferably, at least 1.0 wt. %; more preferably at least 1.1 wt. %; even more preferably at least 1.2 wt. %; most preferably at least 1.3 wt. % and even most preferably at least 1.5 wt. % or at least 1.8 wt. %; or at least 2.0 wt. %.

For example, the grafting agent is provided in a content of at most 10.0 wt. % or at most 8.0 wt. % based on the total weight of the polyethylene-containing material; preferably, at most 6.0 wt. %; more preferably, at most 5.5 wt. %; even more preferably at most 5.0 wt. %; most preferably at most 4.5 wt. % and even most preferably at most 4.0 wt. %.

The grafting agent is introduced in the extruder by the main hoper, for example via a specific dosing system, or via a lateral injection in the extruder; preferably, the grafting agent is introduced via the main hoper.

The step of providing a grafting agent may further comprise providing one or more additives in addition to the grafting agent. For example, one or more additives such as, by way of example, antioxidants, light stabilizers, acid scavengers, flame retardants, lubricants, antistatic additives, nucleating/clarifying agents, colourants, slip agents, anti-blocking agents, processing aids and any mixture thereof.

Although peroxides are not required, in an embodiment, the process further comprises providing one or more peroxides in addition to the grafting agent.

For example, the content of peroxide is at most 1000 ppm based on the total weight of the polyethylene-containing material; preferably at most 800 ppm; more preferably at most 500 ppm; even more preferably at most 200 ppm and most preferably at most 100 ppm.

For example, the content of peroxides is ranging from 0 to 1000 ppm based on the total weight of the polyethylene-containing material; preferably from 10 to 800 ppm; more preferably from 20 to 500 ppm, even more preferably from 30 to 250 ppm and most preferably from 50 to 100 ppm.

For example, the one or more peroxides are or comprise organic peroxides selected from the group consisting of diacetyl peroxide, cumyl-hydro-peroxide, dibenzoyl peroxide, dialkyl peroxide, 2,5-methyl-2,5-di(terbutylperoxy)-hexane, and combinations thereof.

In a preferred embodiment, the process is devoid of a step of providing one or more peroxides in addition to the grafting agent. In such an embodiment no peroxides are used so that the content of peroxide is 0 ppm.

The Compatibilizer and the Step (e) Recovering a Grafted Polyethylene being the Compatibilizer

Step (e) comprises recovering a compatibilizer that is the grafted and treated polyethylene-containing material.

For example, the compatibilizer has a melt index (MI₂ T) ranging from 25 to 450.0 g/10 min as determined according to ISO 1133-2011 at 190° C. under a load of 2.16 kg. For example, the compatibilizer has a melt index (MI₂ T) ranging from 30.0 to 420.0 g/10 min or from 35.0 to 400.0, or from 40 to 400.0 g/10 min, or from 40 to 380.0 g/10 min or from 40 to 350.0 g/10 min as determined according to ISO 1133-2011 at 190° C. under a load of 2.16 kg; preferably, ranging from 42.0 to 280.0 g/10 min; more preferably ranging from 45.0 to 250.0 g/10 min; even more preferably ranging from 50 to 240.0 g/10 min or from 55.0 to 230.0 g/10 min or 60.0 to 220.0 g/10 min or 65.0 to 230.0 g/10 min, or from 70.0 to 210.0 g/10 min or from 80.0 to 230.0 g/10 min, most preferably from 80.0 to 200.0 g/10 min; and even most preferably from 100.0 to 220.0 g/10 min, or from 130.0 to 210.0 g/10 min or from 150.0 to 200.0 g/10 min.

For example, the compatibilizer has a melt index MI₂ of at most 450.0 g/10 min as determined according to ISO 1133-2011 at 190° C. under a load of 2.16 kg; preferably, at most 420.0 g/10 min or at most 400.0 g/10 min or at most 380.0 g/10 min or at most 350.0 g/10 min; more preferably, at most 320.0 g/10 min or at most 300.0 g/10 min; even more preferably, at most 280.0 g/10 min, or at most 250.0 g/10 min; most preferably, at most 240.0 g/10 min, or at most 230.0 g/10 min; or at most 220.0 g/10 min or at most 210.0 g/10 min; and even most preferably, at most 200.0 g/10 min or at most 190.0 g/10 min.

For example, the compatibilizer has a melt index MI₂ of at least 25.0 g/10 min; preferably, at least 30.0 g/10 min or at least 35.0 g/10 min or at least 40.0 g/10 min or at least 42.0 g/10 min or at least 45.0 g/10 min; more preferably, at least 50.0 g/10 min, or at least 65.0 g/10 min; even more preferably, at least 80.0 g/10 min, or at least 90.0 g/10 min; most preferably, at least 100.0 g/10 min, or at least 110 g/10 min; and even most preferably, at least 130.0 g/10 min; or at least 150.0 g/10 min or at least 160 g/10 min.

For example, the grafting agent is present in the compatibilizer at a content ranging from 0.8 to 5.0 wt. % based on the total weight of the compatibilizer; preferably from 0.9 to 4.0 wt. %; more preferably from 1.0 to 3.5 wt. %; even more preferably from 1.1 to 2.5 wt. %; and most preferably from 1.2 to 2.2 wt. %, or from 1.5 to 3.5 wt. %, or from 1.5 to 3.0 wt. %. It is understood that the grafting agent content represents the grafted content as determined by titration and does not include the unreacted grafting agent. In other words, the grafting agent content determination is performed after purification as described in the methods. Purification can include a venting procedure performed at the end of the extruder. The compatibilizer (i.e., the grafted polyethylene) corresponds to the starting material that has been grafted and thermally treated to increase the melt index.

In particular, it was found that the compatibilizer has a ratio of complex viscosity at a frequency of 0.1 rad/sec to the complex viscosity at a frequency of 100 rad/sec of at most 20, said ratio being measured at 190° C.; preferably, of at most 18; preferably, of at most 15; preferably, of at most 12; preferably, of at most 10.0; preferably, of at most 9.0; more preferably, of at most 8.5; even more preferably, of at most 8.0; and most preferably, of at most 7.0.

In an embodiment, the compatibilizer has a complex viscosity at 0.1 rad/sec at 190° C. of at most 25,000 Pa·s; preferably at most 22,000 Pa·s; preferably at most 20,000 Pa·s; preferably at most 18,000 Pa·s; more preferably at most 15,000 Pa·s; even more preferably of at most 12,000 Pa·s most preferably of at most 10,000 Pa·s; and even most preferably of at most 9,000 Pa·s; or at most 8,000 Pa·s, or at most 5,000 Pa·s, or at most 4,000 Pa·s, or at most 3,500 Pa·s, or at most 3,000 Pa·s, or at most 2,500 Pa·s, or at most 2,300 Pa·s,

In an embodiment, the compatibilizer has a complex viscosity at 0.1 rad/sec at 190° C. ranging from 200 to 25,000 Pa·s; preferably from 250 to 22,000 Pa·s; preferably from 300 to 20,000 Pa·s; preferably from 350 to 18,000 Pa·s; more preferably from 380 to 15,000 Pa·s; even more preferably from 400 to 12,000 Pa·s; most preferably from 410 to 10,000 Pa·s; and even most preferably from 410 to 9,000 Pa·s; or from 400 to 8,000 Pa·s, or from 400 to 5,000 Pa·s.

With preference, the compatibilizer has an Mz/Mw of at most 7.0 as determined by size exclusion chromatography; preferably at most 6.0; preferably at most 5.0.

For example, the compatibilizer further has an Mw/Mn ranging from 2.0 to 4.5 as determined by size exclusion chromatography; preferably from 2.1 to 4.4; more preferably from 2.2 to 4.2;

even more preferably from 2.3 to 4.0 or from 2.4 to 3.9.

For example, the compatibilizer further has a tan delta (G″/G′) at 0.1 rad at 190° C. above 2.5; preferably of at least 3.0; more preferably of at least 5.0 and even more preferably of at least 10.0.

In one embodiment, the polyethylene-containing material further has a tan delta (G″/G′ measured at 0.1 rad/s at 190° C.) of at most 3.0; preferably of at most 2.6.

In one embodiment, the polyethylene-containing material further has a tan delta (G″/G′ measured at 0.1 rad/s at 190° C.) ranging from 0.5 to 3.0; preferably, from 0.8 to 2.6.

### Test Methods

The melt flow index MI₂ of the polyethylene is determined according to ISO 1133-2011 at 190° C. under a load of 2.16 kg.

The HLMI of the polyethylene is determined according to ISO 1133-2011 at 190° C. under a load of 21.6 kg.

The Mn, Mw, Mz, Mw/Mn and Mz/Mw: The molecular weight (Mₙ (number average molecular weight), M_{w} (weight average molecular weight) and molecular weight distributions D (Mw/Mn) and D′ (Mz/Mw) were determined by size exclusion chromatography (SEC. Briefly, a GPC-IR5 from Polymer Char was used: 10 mg polyethylene sample was dissolved at 160° C. in 10 ml of trichlorobenzene for 1 hour. Injection volume: about 400 μl, automatic sample preparation and injection temperature: 160° C. Column temperature: 145° C. Detector temperature: 160° C. Two Shodex AT-806 MS (Showa Denko) and one Styragel HT6E (Waters) columns were used with a flow rate of 1 ml/min. Detector: Infrared detector (2800-3000 cm-1). Calibration: narrow standards of polystyrene (PS) (commercially available). Calculation of molecular weight Mi of each fraction i of eluted polyethylene is based on the Mark-Houwink relation (log₁₀(M_{PE})=0.965909×log₁₀(M_{PS})−0.28264) (cut off on the low molecular weight end at M_{PE}=1000).

The molecular weight averages used in establishing molecular weight/property relationships are the number average (Mₙ), weight average (M_{w}) and z average (M_{z}) molecular weight. These averages are defined by the following expressions and are determined from the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {W}_{i}} = \frac{{\sum }_{i} {h}_{i} {M}_{i}}{{\sum }_{i} {h}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD) is then calculated as Mw/Mn.

The comonomer content in polyethylene is determined by ¹³C-NMR analysis of pellets according to the method described by G. J. Ray et al. (Macromolecules, 1977, 10, (4), 773-778).

Crystallisation temperature (Tc) and Melting temperature (Tm) are determined according to ISO 11357-3:2018 on a DSC Q2000 instrument by TA Instruments. To erase the thermal history the samples are first heated to 220° C. and kept at 220° C. for 3 minutes. Then the polymer is cooled at −20° C./min. up to 20° C. and kept at 20° C. for 3 minutes. The crystallization temperature is determined during this cooling step. The crystallization temperature Tc corresponds to the temperature of the extremum of the spectrogram presenting the heat flux associated with the polymer as a function of the temperature during its cooling. The polymer is then melted up to 220° C. at 20° C./min. and the melting temperature is determined during this heating step. The melting temperature corresponds to the temperature of the extremum of the spectrogram presenting the heat flux associated with the polymer as a function of the temperature during its melting.

The density was measured according to the method of standard ISO 1183-1:2012 (immersion method) at a temperature of 23° C.

Complex shear modulus and viscosity: The complex shear modulus G*(w)=G′(w)+jG″(w) (J²=−1, G′(w): storage modulus and G″(w): loss modulus) was determined using a DHR-2, a stress-controlled rheometer from TA Instruments. Frequency sweeps have been carried out in the linear domain (1% strain) at 190° C. from 100 to 0.01 rad·s⁻¹ under nitrogen flow to prevent thermal oxidative degradation. The used geometry was 25 mm diameter parallel plates with a 2 mm gap. The samples (25 mm diameter, 2 mm thickness) for these experiments were obtained beforehand using an injection press (Babyplast type). The complex viscosity η*(ω) is calculated according to the following equation of the linear viscoelasticity:

$$\vert {η}^{*} ( ω ) \vert = {[ {( \frac{{G}^{′} ( ω )}{ω} )}^{2} + {( \frac{{G}^{″} ( ω )}{ω} )}^{2} ]}^{1 / 2}$$

### Determination of the MA Content (Titration)

Few grams of the grafted product are purified in a vacuum oven at 140° C. for 24 h, this step is crucial to remove all of the unreacted maleic acid by evaporation beyond the melting temperature of the polymer. This step is not needed when a venting procedure is performed at the end of the extruder.

The grafted maleic anhydride reacts with water hence forming the maleic acid form (diacid) which is optically active due to the presence of one asymmetric carbon in its molecule.

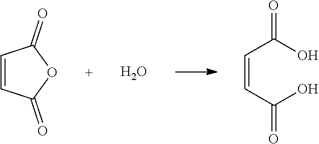 [SMILES: O=C1C=CC(=O)O1 ; O ; O=C(O)/C=C\C(=O)O]

### Hydrolysis of Maleic Anhydride to Form Maleic Acid

The MA content of the purified products is calculated from the acid number. 0.5 g of the grafted polymer with maleic anhydride are dissolved in xylene at 120° C. in a flask with high agitation for 30 min. Then water drops are added to the solution after lowering the temperature to c.a. 100° C. The hot solution is then titrated immediately with ethanolic 0.05N KOH using three to four drops of 1% thymol blue in DMF indicator, the equivalence is observed when the solution turns from clear yellow to blue. A 0.5-1.0 mL excess of KOH solution is added, and the deep blue color was back-titrated to yellow end point by the addition of 0.05N isopropanolic HCl to the hot solution. The ethanolic KOH solution is previously standardized against a solution of known concentration of potassium hydrogen phthalate in water using phenolphthalein indicator.

The acid number and the maleic anhydride content were calculated as follows:

$$Acid Number ( mg KOH / g ) = \frac{{V}_{eq} \times {N}_{KOH} \times 56 , 1}{{m}_{polymer - g - MA}}$$

$$MA ( \% ) = \frac{acid number \times 98}{2 \times 561}$$

The grafted MA content is classified into 4 categories:
Low: 0.2-0.5%
Medium: 0.5-0.8%
High: 0.8-1%
Very high: above 1% (1-1.5%)
Ultra high: above 1.5%

The Young Modulus, Strain at Break, Stress at Break, were determined according to ISO-527-2: Uniaxial tensile strength tests were performed on a Shimadzu AG-X testing machine equipped with a 10 kN cell and an extensometer at room temperature. To comply with ISO-527-2 standard, the testing speed was 50 mm/min to measure yield stress and elongation at break, and 1 mm/min to determine the Young's modulus. 10 DAM (dry-as-molded) samples were tested for each formulation.

The Impact Strength was determined according to ISO 179/1eC: C-Notched Charpy impact test samples were performed on DAM samples (80×10×4 mm) at ambient temperature following ISO 179/1eC. At least ten samples were tested for each series to assure good reproducibility of the measurements.

### Scanning Electron Microscopy (SEM)

Scanning electron microscopy (SEM) observations were carried out on an FEI Quanta 250 electron microscope using an acceleration voltage of 10 kV and under a high vacuum. Non-stretched flowing extruded rods were collected at the die end, they were cryofractured in a nitrogen bath and then placed on sample holders. Samples were sputter-coated with a 10 nm layer of carbon to limit static charging.

### EXAMPLES

The following non-limiting examples illustrate the disclosure

### Example 1—Preparation of the Inventive Compatibilizers

The polyethylene-containing material was selected to be a virgin polyethylene

PE1=Polyethylene HDPE 5502 commercialised by TotalEnergies. The density according to ISO 1183-1:2012 is 0.954 g/cm³; the MI₂ according to ISO 1133-2011 (190° C., 2.16 kg) is 0.25 g/10 min; the HLMI according to ISO 1133-2011 (190° C., 21.6 kg) is 22 g/10 min. The polyethylene was produced using a chromium-based catalyst.

The storage modulus (G′) at 0.1 rads and at 190° C. was measured to be 1,855 Pa and the loss modulus (G″) at 0.1 rads and at 190° C. was measured to be 2,798 Pa; resulting in a tan delta (G″/G′) of 1.5.

Table 1 provides the molar mass distribution obtained using size exclusion chromatography.

TABLE 1

| PE1 | Mn (Da) | Mw (Da) | Mz (Da) | Mw/Mn | Mz/Mw |
|---|---|---|---|---|---|
| HDPE5502 | 19000 | 150000 | 1380000 | 8 | 9.2 |

PE1 was elected as, from a melt index point of view, it is representative of the melt index of important recycled polyethylene feedstocks.

### The Maleic Anhydride

MA1=is a commercial maleic anhydride provided by sigma Aldrich (Merck) and received in flake forms. It is micronized and used directly in the process. Maleic anhydride rapidly hydrolyzes to form maleic acid in the presence of water.

TABLE 2
Characteristics and properties of maleic anhydride.

| | |
|---|---|
| Preferred name | Furan-2,5-dione |
| CAS Number | 108-31-6 |
| Molar Mass (g/mol) | 98.06 |
| Formula | C2H2(CO)2O |
| Melting point (° C.) | 52.8 |
| Boiling point (° C.) | 202 |
| Appearance | White crystals or needles, flakes/powder |
| Density (g/cm³) | 1.48 |
| Structure | 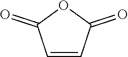 |

### The Screw Profile P1

The products were obtained by twin screw extrusion using a co-rotating extruder from Leistritz ZSE18 MAXX/HPe 68D (cylinder diameter=18 mm) with 1200 rpm as the maximum speed. This extruder includes 17 heating/cooling (ZIK) zones (excluding the die) that withstand a maximum temperature of 450° C. The feeding was exclusively made in the feeding zone and was made by gravimetry. The diameter of the die is 3 mm.

The screw profile P1 is illustrated in FIG. 1 and is composed of four major segments:

The first segment is the one of the feeding zones, composed of successive conveying elements. The second segment is composed of progressive high shear screw elements successive kneading block elements with disks offset by 30 degrees, 60 degrees, and 90 degrees and a disk width of at least 0.3 D wherein D is the screw diameter. The third segment consists of alternating conveying screw elements and kneading block elements. The third segment comprises the hot zone of the extruder.

The fourth and last segment consists of conveying elements and the die.

The temperature profile starts with a low temperature in the feeding zone (65° C.) and is increased progressively to 250° C. in the second segment (blending-fusion segment, Z3-Z5). Then the temperature is increased progressively in Z6-Z7 (300 and 320° C. respectively) to reach the high-temperature Tₛ fixed in the zones Z8-Z12. Afterwards, the temperature is lowered progressively until it reaches 200° C. in Z17 and the die to cool the melt. The one or more hot zones of the extruder are hence aimed in the zones Z8-Z12.

The screw profile P1

| No. element | mm | Leistritz name |
|---|---|---|
| 1 | 30 | GFA-2-20-30 |
| 2 | 60 | GFF-2-30-30-A |
| 3 | 90 | GFF-2-30-30-A |
| 4 | 120 | GFF-2-30-30-A |
| 5 | 150 | GFA-2-30-30 |
| 6 | 165 | GFA-2-30-15 |
| 7 | 195 | GFA-2-20-30 |
| 8 | 225 | GFA-2-20-30 |
| 9 | 240 | KB 4-2-15-30°-Re |
| 10 | 255 | KB 4-2-15-30°-Re |
| 11 | 270 | KB 4-2-15-60°-Re |
| 12 | 285 | KB 4-2-15-60°-Re |
| 13 | 300 | KB 4-2-15-90° |
| 14 | 315 | KB 4-2-15-90° |
| 15 | 330 | GFA-2-20-15 |
| 16 | 360 | GFA-2-30-30 |
| 17 | 390 | GFA-2-30-30 |
| 18 | 420 | GFA-2-30-30 |
| 19 | 450 | GFA-2-30-30 |
| 20 | 465 | GFA-2-20-15 |
| 21 | 480 | GFA-2-20-15 |
| 22 | 510 | GFA-2-20-30 |
| 23 | 540 | GFA-2-20-30 |
| 24 | 555 | KB 4-2-15-30°-Re |
| 25 | 570 | KB 4-2-15-60°-Re |
| 26 | 585 | GFA-2-20-15 |
| 27 | 600 | GFA-2-20-15 |
| 28 | 630 | GFA-2-20-30 |
| 29 | 660 | GFA-2-20-30 |
| 30 | 675 | KB 4-2-15-60°-Re |
| 31 | 690 | KB 4-2-15-90° |
| 32 | 720 | GFA-2-30-30 |
| 33 | 750 | GFA-2-30-30 |
| 34 | 780 | GFA-2-30-30 |
| 35 | 810 | GFA-2-30-30 |
| 36 | 840 | GFA-2-20-30 |
| 37 | 870 | GFA-2-20-30 |
| 38 | 900 | GFA-2-20-30 |
| 39 | 915 | KB 4-2-15-30°-Re |
| 40 | 930 | KB 4-2-15-60°-Re |
| 41 | 960 | GFA-2-30-30 |
| 42 | 990 | GFA-2-20-30 |
| 43 | 1020 | GFA-2-20-30 |
| 44 | 1035 | KB 4-2-15-60°-Re |
| 45 | 1050 | KB 4-2-15-60°-Re |
| 46 | 1080 | GFA-2-30-30 |
| 47 | 1110 | GFA-2-30-30 |
| 48 | 1140 | GFA-2-30-30 |
| 49 | 1170 | GFA-2-30-30 |
| 50 | 1200 | GFA-2-30-30 |
| 51 | 1215 | GFA-2-20-15 |
| 52 | 1245 | GFA-2-20-30 |
| 53 | 1275 | GFA-2-20-30 |

The barrel configuration

| No. element | mm | Leistritz name |
|---|---|---|
| A | 75 | Zyl-E |
| B | 76 | Wärmesperre |
| C | 151 | Zyl-0/MC |
| D | 226 | Zyl-0/MC |
| E | 301 | Zyl-0/MC |
| F | 376 | Zyl-0/MC |
| G | 451 | Zyl-0/MC |
| H | 526 | Zyl-0/MC |
| I | 601 | Zyl-0/MC |
| J | 676 | Zyl-0/MC |
| K | 751 | Zyl-0/MC |
| L | 826 | Zyl-0/MC |
| M | 901 | Zyl-0/MC |
| N | 976 | Zyl-0/MC |
| O | 1051 | Zyl-0/MC |
| P | 1126 | Zyl-0/MC |
| Q | 1201 | Zyl-1/MC |
| R | 1276 | Zyl-0/MC |

### The Grafting by Extrusion at High Temperature and the Results

The products were obtained by twin screw extrusion using a co-rotating extruder from Leistritz ZSE18 MAXX/HPe 68D (cylinder diameter=18 mm) with 1200 rpm as the maximum speed. This extruder includes 17 heating/cooling (ZIK) zones (excluding the die) that withstand a maximum temperature of 450° C. The feeding was exclusively made in the feeding zone and was made by gravimetry. The diameter of the die is 3 mm.

The polymer joint is driven in a cooling water bath of 2.5 m tall that ends with an airflow drying system before entering the pelletizer. The extruder is equipped with 3 efficient fume extraction arms.

The first screw profile experiences aimed to compare the properties of pure products (without maleic anhydride), that underwent merely the same process conditions as the grafted products (with maleic anhydride, MAᵢ in the following refers to the initial introduced MA wt % in the mixture).

TABLE 3
Process conditions, Molar masses, grafted MA contents and MI₂ results for experiments
obtained with the screw profile “P1”. (Molar masses are obtained by size exclusion
chromatography and rounded, grafted MA contents are obtained by Acid-base titration)

| T | N | Q | MAᵢ | Mn | Mw | Mz | Mw/ | Mz/ | MI₂ (g/ | g-MA |
|---|---|---|---|---|---|---|---|---|---|---|
| (° C.) | (rpm) | (kg/h) | (%) | (Da) | (Da) | (Da) | Mn | Mw | 10 min) | (%) |
| Raw HDPE5502 | | | 0 | 19,000 | 150,000 | 1,383,000 | 8.0 | 9.2 | 0.4 | 0.0 |
| 200 | 400 | 3 | 0 | 19,000 | 151,000 | 1,317,000 | 8.0 | 8.7 | 0.4 | 0.0 |
| 200 | 400 | 3 | 3 | 18,750 | 157,000 | 1,575,000 | 8.4 | 10.0 | 0.4 | 0.1 |
| 320 | 400 | 3 | 0 | 18,700 | 111,000 | 496,000 | 5.9 | 4.5 | 0.2 | 0.0 |
| 320 | 400 | 3 | 3 | 17,050 | 93,000 | 402,000 | 5.4 | 4.3 | 0.2 | 0.5 |
| 360 | 400 | 3 | 0 | 17,650 | 77,000 | 239,000 | 4.4 | 3.1 | 0.8 | 0.0 |
| 360 | 400 | 3 | 3 | 15,000 | 54,500 | 143,000 | 3.6 | 2.6 | 1.8 | 1.1 |
| 390 | 400 | 3 | 0 | 15,300 | 49,500 | 114,500 | 3.2 | 2.3 | 8.2 | 0.0 |
| 390 | 400 | 3 | 3 | 12,650 | 37,000 | 78,500 | 2.9 | 2.1 | 28.2 | 1.3 |

From the grafted polyethene produced the one showing an MI₂ of 28.2 g/10 min is selected and named MAT11. MAT11 was found to have a complex viscosity at 0.1 rad/sec at 190° C. of 250 Pa·s and a tan delta (G″/G′) at 0.1 rad at 190° C. of 23.

The raw HDPE 5502 presents high molar mass and high Mw/Mn and Mz/Mw, it is representative of polyethylene PCR (rPE), having an MI₂ of 0.12 g/10 min. From this polyethylene, several experiments have been made to control the variation of the molar masses and the grafting content with the process conditions following this screw profile.

At 200° C., the molar masses of polyethylene do not vary compared to that of the polyethylene. It is noted that the Mz/Mw has slightly increased. At this temperature, the polyethylene is thermally stable, and the grafted content of maleic anhydride is almost nil. No change in the MI₂ values is noted.

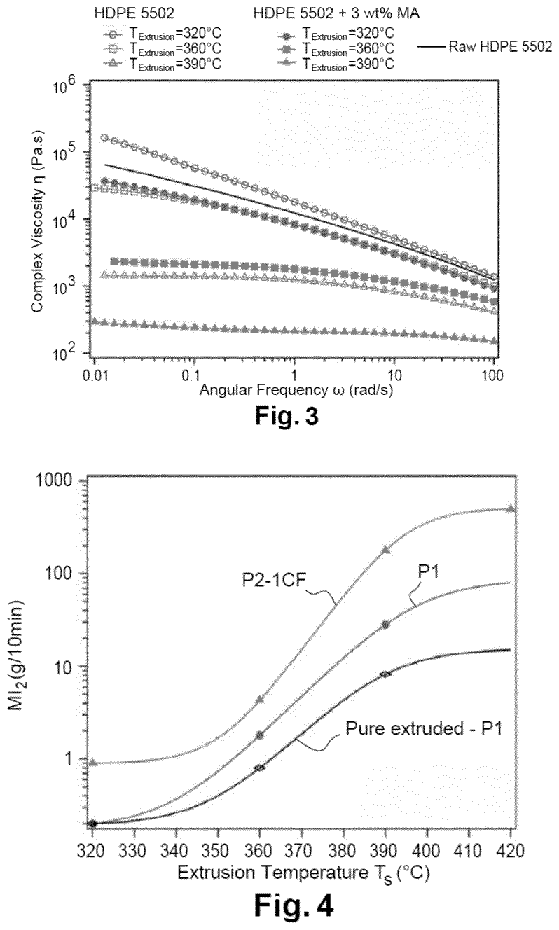

Based on thermograms, it is believed that the temperature of 320° C. corresponds to the beginning of the production of free radicals and chain scissions (β-scission). Moreover, some recombination reactions of macro-radicals (chains of polyethylene with one radical) can be noted, this can be referred to as branching or some crosslinking reactions. The impact of this kind of reaction can be seen in the rheology data where the measured complex viscosity of the extruded samples at 320° C. without maleic anhydride is higher than that of the HDPE 5502 (FIG. 3).

The presence of maleic anhydride in the formulations at 320° C. has resulted in a decrease in the complex viscosity with respect to the HDPE 5502. There is a clear impact of the presence of maleic anhydride at high temperatures on the modification of polyethylene (chain scissions are probably more induced in the presence of maleic anhydride). In both cases, with and without maleic anhydride, there is a clear decrease in the molar masses, this decrease is greater for the formulation with maleic anhydride (Mw/Mn and Mz/Mw decreased significantly). The Mw decreased by 26 and 38% for the pure and the grafted sample, respectively. No change in MI₂ values is to be noted.

The HDPE 5502 is representative of polyethylene PCR and it contains in its recipe some antioxidants and stabilizers that would enhance its thermal stability at high temperatures. Despite that there is production of free radicals from the beginning of the modification of polyethylene; it stays limited by the presence of antioxidants and stabilizers in the system, hence hindering the reactions of grafting of maleic anhydride. This is why the grafted MA content at 320° C. is low (0.5%).

At 360° C., there is a higher production of radicals than in the experiment at 320° C. allowing the addition of maleic anhydride on the polyethylene chains. The grafted MA content is very high (1.1%). A higher decrease in molar masses and molar mass distribution Mw/Mn and Mz/Mw is observed due to the dominant chain scission reactions; the Mw decreased by 48 and 64% for the pure and the grafted sample, respectively. The complex viscosity and the molar masses decrease more in the experiment with maleic anhydride than that with pure polyethylene. There is a clear increase in the MI₂ of 100 and 350% for pure and grafted samples, respectively.

At 390° C., the production of free radicals in situ is at its highest, and the grafting of maleic anhydride is very high (above 1%: 1.3%). Moreover, the molar masses and their distribution have been reduced drastically, The Mw decreased by 67 and 75% for the pure and the grafted sample, respectively. Moreover, the complex viscosity is reduced especially for the formulation with maleic anhydride; the complex viscosity is Newtonian on the whole range of the angular frequency.

All in all, the functionalization of polyethylene with maleic anhydride by reactive extrusion through thermal initiation was successful using the presented screw profile. A grafted MA content up to 1.3 wt. % and an MI₂ of 28 g/10 min were obtained. The obtained products have lower molar masses, lower than those extruded without maleic anhydride. It is hence concluded an additional effect of maleic anhydride on the modification and the increase of MI₂.

### The Screw Profile P2-1CF

To intensify the “Flash reactive extrusion” desired process, a second screw profile P2-1-CF was conceived and is illustrated in FIG. 2. This screw profile aims to increase the modification and the time of exposition of the melt to high temperatures. For this reason, in addition to the fusion and mixing zone at the beginning of the screw profile, high-shear screw elements were added in the zones Z8-Z12 where Ts is the high temperature for each extrusion experiment. To increase the filling ratio, and hence the time of exposition of the melt to the high temperature, a reverse element (i.e. a left-handed screw element) was added at the end of this segment.

The screw profile P2-1CF

| No. element | mm | Leistritz name |
|---|---|---|
| 1 | 30 | GFA-2-20-30 |
| 2 | 60 | GFF-2-30-30-A |
| 3 | 90 | GFF-2-30-30-A |
| 4 | 120 | GFF-2-30-30-A |
| 5 | 150 | GFA-2-30-30 |
| 6 | 165 | GFA-2-20-15 |
| 7 | 195 | GFA-2-20-30 |
| 8 | 225 | GFA-2-20-30 |
| 9 | 240 | KB 4-2-15-30°-Re |
| 10 | 255 | KB 4-2-15-30°-Re |
| 11 | 270 | KB 4-2-15-60°-Re |
| 12 | 285 | KB 4-2-15-60°-Re |
| 13 | 300 | KB 4-2-15-90° |
| 14 | 315 | KB 4-2-15-90° |
| 15 | 330 | GFA-2-20-15 |
| 16 | 360 | GFA-2-30-30 |
| 17 | 390 | GFA-2-30-30 |
| 18 | 420 | GFA-2-30-30 |
| 19 | 450 | GFA-2-30-30 |
| 20 | 480 | GFA-2-30-30 |
| 21 | 495 | GFA-2-20-15 |
| 22 | 510 | GFA-2-20-15 |
| 23 | 540 | GFA-2-20-30 |
| 24 | 570 | GFA-2-20-30 |
| 25 | 600 | GFA-2-20-30 |
| 26 | 630 | GFA-2-20-30 |
| 27 | 660 | GFA-2-20-30 |
| 28 | 675 | KB 4-2-15-30°-Re |
| 29 | 690 | KB 4-2-15-30°-Re |
| 30 | 705 | KB 4-2-15-60°-Re |
| 31 | 720 | KB 4-2-15-60°-Re |
| 32 | 735 | KB 4-2-15-60°-Re |
| 33 | 750 | KB 4-2-15-90° |
| 34 | 765 | GFA-2-20-15-L |
| 35 | 795 | GFA-2-30-30 |
| 36 | 825 | GFA-2-30-30 |
| 37 | 855 | GFA-2-30-30 |
| 38 | 885 | GFA-2-30-30 |
| 39 | 915 | GFA-2-30-30 |
| 40 | 945 | GFA-2-30-30 |
| 41 | 975 | GFA-2-30-30 |
| 42 | 1005 | GFA-2-30-30 |
| 43 | 1020 | GFA-2-20-15 |
| 44 | 1035 | GFA-2-20-15 |
| 45 | 1065 | GFA-2-20-30 |
| 46 | 1095 | GFA-2-20-30 |
| 47 | 1125 | GFA-2-20-30 |
| 48 | 1155 | GFA-2-20-30 |
| 49 | 1185 | GFA-2-20-30 |
| 50 | 1215 | GFA-2-20-30 |
| 51 | 1245 | GFA-2-20-30 |
| 52 | 1275 | GFA-2-20-30 |

The barrel configuration

| No. element | mm | Leistritz name |
|---|---|---|
| A | 75 | Zyl-E |
| B | 76 | Wärmesperre |
| C | 151 | Zyl-0/MC |
| D | 226 | Zyl-0/MC |
| E | 301 | Zyl-0/MC |
| F | 376 | Zyl-0/MC |
| G | 451 | Zyl-0/MC |
| H | 526 | Zyl-0/MC |
| I | 601 | Zyl-0/MC |
| J | 676 | Zyl-0/MC |
| K | 751 | Zyl-0/MC |
| L | 826 | Zyl-0/MC |
| M | 901 | Zyl-0/MC |
| N | 976 | Zyl-0/MC |
| O | 1051 | Zyl-0/MC |
| P | 1126 | Zyl-0/MC |
| Q | 1201 | Zyl-1/MC |
| R | 1276 | Zyl-0/MC |

With this high shear temperature profile, the objective was to increase the MI₂ as well as the grafted MA content.

TABLE 4
Process conditions, Molar masses, grafted MA contents and MI₂ results for experiments
obtained with the screw profile “P2-1CF”. (Molar masses are obtained by size
exclusion chromatography, and grafted MA contents are obtained by Acid-base titration)

| T | N | Q | MAi | Mn | Mw | Mz | Mw/ | Mz/ | MI₂ (g/ | g-MA |
|---|---|---|---|---|---|---|---|---|---|---|
| (° C.) | (rpm) | (kg/h) | (%) | (Da) | (Da) | (Da) | Mn | Mw | 10 min) | (%) |
| Raw HDPE5502 | | | 0 | 19,000 | 150,000 | 1,383,000 | 8.0 | 9.2 | 0.4 | 0 |
| 320 | 400 | 3 | 3 | 15,000 | 54,000 | 149,000 | 3.6 | 2.8 | 0.9 | 0.9 |
| 360 | 400 | 3 | 3 | 14,000 | 44,000 | 1008,000 | 3.1 | 2.3 | 4.9 | 1.4 |
| 390 | 400 | 3 | 3 | 10,000 | 24,000 | 45,000 | 2.5 | 1.9 | 179 | 2.2 |
| 420 | 400 | 3 | 3 | 9,000 | 20,000 | 35,500 | 2.3 | 1.8 | 500 | 1.7 |

The above compatibilizers were named MAT53, MAT 92, MAT57 and MAT147 respectively.
MAT53 (MI₂ of 0.9 g/10 min) was found to have a complex viscosity at 0.1 rad/sec at 190° C. of 2100 Pa·s and a tan delta (G″/G′) at 0.1 rad at 190° C. of 3.
MAT92 (MI₂ of 4.9 g/10 min) was found to have a complex viscosity at 0.1 rad/sec at 190° C. of 1250 Pa·s and a tan delta (G″/G′) at 0.1 rad at 190° C. of 15.
MAT57 (MI₂ of 179 g/10 min) was found to have a complex viscosity at 0.1 rad/sec at 190° C. below 200 Pa·s and a tan delta (G″/G′) at 0.1 rad at 190° C. of 83.
MAT (MI₂ of 500 g/10 min) was found to have a complex viscosity at 0.1 rad/sec at 190° C. much lower than MAT57 (<<200 Pa·s) and a tan delta (G″/G′) at 0.1 rad at 190° C. higher than 83.

The same tendencies were obtained with this screw profile. At 320° C., at the beginning of the modification of polyethylene, the molar masses decreased drastically due to the high shear intensity of the screw profile. Mw decreased by 64% compared to the raw HDPE 5502, this decrease was followed by an increase in MI₂ of 125%. The reaction of grafting of maleic anhydride on polyethylene has occurred, and the grafted MA content is high (0.9%). At 360° C., above the temperature of the beginning of the modification of polyethylene, the decrease in molar masses is greater, the Mw has decreased by 76% while the MI₂ was recorded at 4.3 g/10 min for the experiment at 400 rpm. The grafted MA content was ultra-high at 400 rpm (˜1.6%). At 390° C., the grafted MA content recorded its highest value among all of the conducted experiments, it is ultra-high (>2%) at 400 rpm. As for the molar masses, the decrease was brutal and was for Mw of 85% at 400 rpm. The MI₂ was highly increased and it reached 179 g/10 min. All of the molar masses decreases were naturally followed by a decrease in Mw/Mn and Mz/Mw and thus a narrowing in the molar mass distributions.

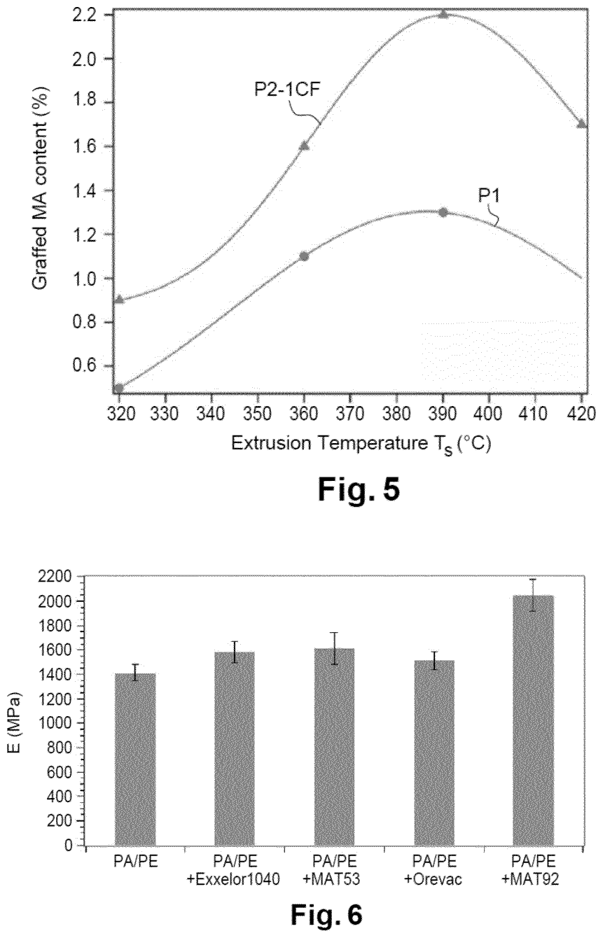

As seen in FIGS. 4 and 5, the MI₂ of the obtained products increases with the temperature as expected. The MI₂ of grafted products is higher than the pure products and it is much higher with the second screw profile than that of the first one, which is a consequence of the longer exposition time to the Flash temperature thanks to the presence of the reverse element at the end of the Flash segment, promoting hence chain scissions. Moreover, for the grafted MA content, both screw profiles have curves that seem to pass through maxima of grafting at 390° C. with a higher grafted MA content for the profile “P2-1CF” (double the grafted content). However, beyond 390° C., the grafted MA content starts decreasing due to violent flash temperatures that promote the degradation of bigger quantities of maleic anhydride. These maxima are observed only on the grafted MA content curves and not on the MI₂ curves as the MI₂ continues increasing notwithstanding the decrease of the grafted MA content.

### Example 2—Selection of the Compatibilizer

MAT ## are compatibilizers according to the present disclosure.
MAT53 is a compatibilizer that has an MI₂ of 0.9 g/10 min and a grafting agent content of 0.9 wt. % based on the total weight of the compatibilizer.
MAT92 is a compatibilizer that has an MI₂ of 4.9 g/10 min and a grafting agent content of 1.4 wt. % based on the total weight of the compatibilizer.
MAT11 is a compatibilizer that has an MI₂ of 28.2 g/10 min and a grafting agent content of 1.3 wt. % based on the total weight of the compatibilizer.
MAT57 is a compatibilizer that has an MI₂ of 179 g/10 min and a grafting agent content of 2.2 wt. % based on the total weight of the compatibilizer.
MAT147 is a compatibilizer that has an MI₂ of 500 g/10 min and a grafting agent content of 1.7 wt. % based on the total weight of the compatibilizer.

Commercially available compatibilizers have been selected for comparative purposes:
Exxelor 1040 is commercially available from ExxonMobil and is a PE-g-MA compatibilizer that has an MI₂ of 1 g/10 min and a grafting agent content of 1 wt. % based on the total weight of the compatibilizer
Orevac 18507 is commercially available from Arkema and is a PE-g-MA compatibilizer that has an MI₂ of 5 g/10 min and a grafting agent content of 1.4 wt. % based on the total weight of the compatibilizer

### Example 3—Preparation of the Polymer Compositions—Comparison with Commercial Products

PE/PA blends have been prepared with or without compatibilizer

As a “blank” reference, PE and PA are blended without compatibilizer

5 wt % of MA-g-PE (i.e., the compatibilizer) were added (substitution of a part of PE); the final composition PE/PA/MA-g-PE thus becomes 45/50/5.

The polyethylene used in the blends was the same as the one used to prepare the inventive compatibilizers (i.e., PE1)

PE1=Polyethylene HDPE 5502 commercialised by TotalEnergies. The density according to ISO 1183-1:2012 is 0.954 g/cm³; the MI₂ according to ISO 1133-2011 (190° C., 2.16 kg) is 0.25 g/10 min; the HLMI according to ISO 1133-2011 (190° C., 21.6 kg) is 22 g/10 min. The polyethylene was produced using a chromium-based catalyst.

Polyamide was selected as the polymer having a polar functional group. The polyamide used was PA6 AKULON F223D commercially available from DSM with a melt flow volume rate of 44 cm3/10 min as determined by ISO 1133 at 260° C. under a load of 2.16 kg.

Properties of the polymer composition prepared with the compatibilizer Exxelor 1040 are to be compared to the polymer composition prepared with MAT53 since they both have similar MI₂ (1 vs 0.9 g/10 min) and grafting agent content (1 vs. 0.9 wt. %).

Properties of the polymer composition prepared with the compatibilizer Orevac 18507 are to be compared to the polymer composition prepared with MAT92 since they both have similar MI₂ (5 vs. 4.9 g/10 min) and grafting agent content (1.4 vs. 1.4 wt. %)

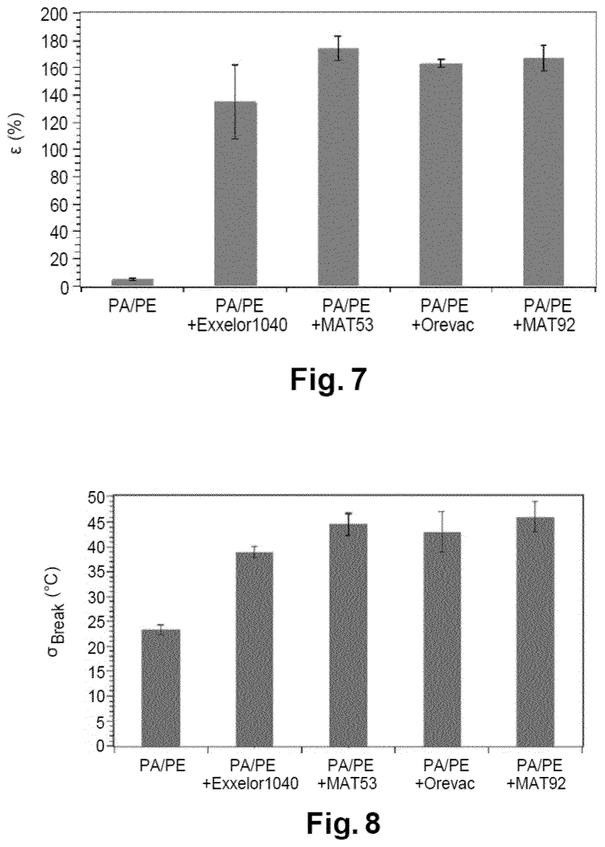

Mechanical properties have been tested and reported in FIGS. 6 to 9

From the results, it can be seen that the use of inventive compatibilizers provides an improved balance of mechanical properties. Indeed, with the same MI₂ and % MA as commercial products, the polymer compositions comprising the inventive compatibilizers exhibited similar mechanical performances as regards the Young Modulus, the Strain at Break and the Stress at Break but improvement for Impact Strength.

### Example 4—Preparation of the Polymer Compositions—Influence of the MI₂ of the Compatibilizer

The results of Example 3 showed that the presence of PE-g-MA already with an MI₂ of 1 g/10 min improves the Impact Strength by comparison of the blend devoid of compatibilizer. It was also found that PE-g-MA with MI₂ of about 5 g/10 min showed higher Impact Strength than those with MI₂ of about 1 g/10 min. Further experiments have been conducted using inventive compatibilizers that showed higher MI₂ such as MAT11 (MI₂ of 28.2 g/10 min), MAT57 (MI₂ of 179 g/10 min) and MAT147 (MI₂ of 500 g/10 min).

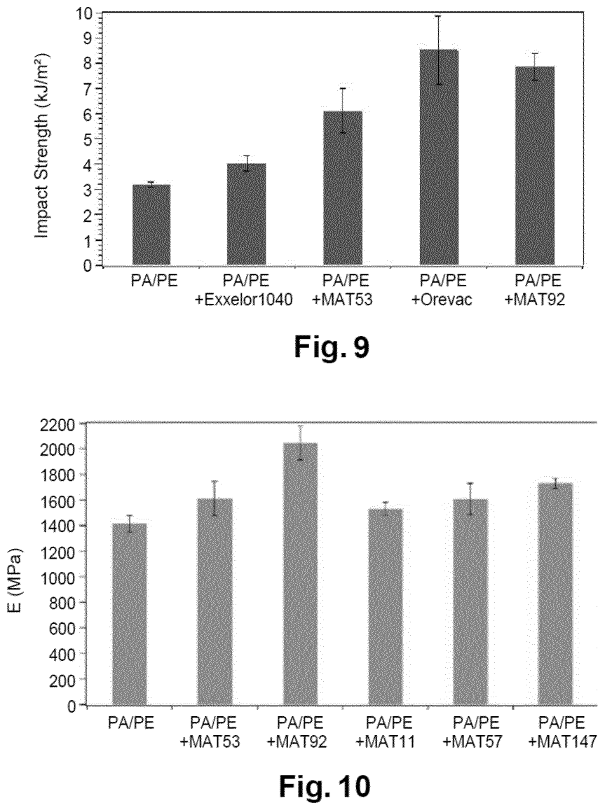

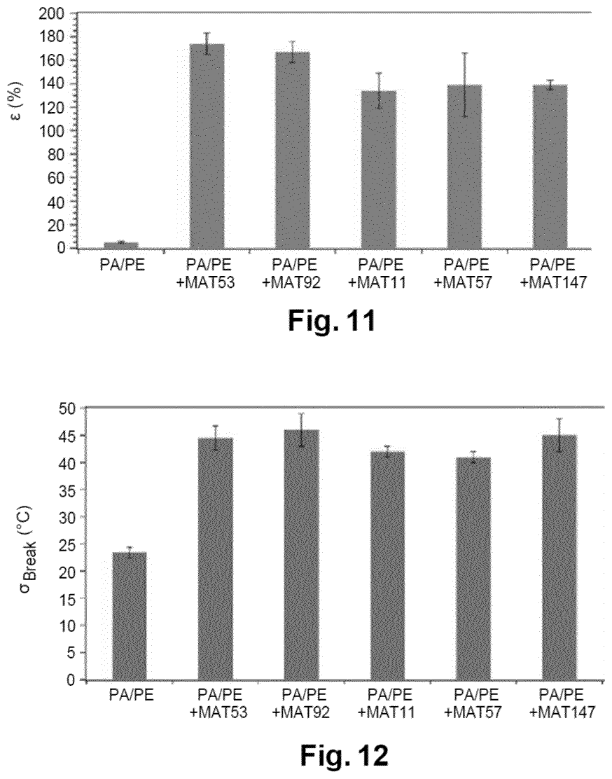

Mechanical properties have been tested and reported in FIGS. 10 to 13

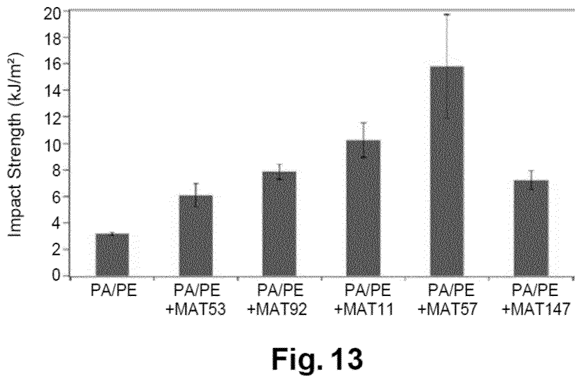

All of the tested PE-g-MA with various MI₂ (up to 500 g/10 min) have successfully compatibilized PE/PA blends. As can be seen from FIG. 13, Impact Strength increased with the MI₂ of the compatibilizer up to an optimum around an MI₂ of 180 g/10 min and then decrease. The use of the inventive compatibilizer with high MI₂ allows a clear improvement of the balance of properties and especially of the impact strength properties.

1. Process to produce a polymer composition comprising
providing from 10 to 90 wt. % of a component A based on the total weight of the polymer composition; wherein the component A is one or more polyethylene resins selected from a high-density polyethylene resin, a medium-density polyethylene resin, a low-density polyethylene resin, a linear low-density polyethylene resin and any mixture thereof;
providing from 90 to 10 wt. % of a component B based on the total weight of the polymer composition; wherein the component B is one or more materials selected from materials having a polar functional group, inorganic polar particles, polymers having a polar functional group, HD silica, fumed silica, carbon-containing particles, carbon fibres, glass fibres, natural fibres, and any mixture thereof;
providing from 0.5 to 20 wt. % of a compatibilizer based on the total weight of the polymer composition; wherein the compatibilizer is a grafted polyethylene, and
melt blending the component A, the component B and the compatibilizer to obtain a polymer composition;
characterized in that the compatibilizer is comprising at least 70 wt. % of polyethylene based on the total weight of the compatibilizer, and has:
a melt index MI₂ ranging from 25 to 450.0 g/10 min as determined according to ISO 1133-2011 at 190° C. under a load of 2.16 kg;
an Mw/Mn ranging from 2.0 to 4.5 as determined by size exclusion chromatography;
a complex viscosity at 0.1 rad/sec at 190° C. of at most 25,000 Pa's;
a grafting agent content ranging from 0.5 to 15.0 wt. % based on the total weight of the compatibilizer; and
a weight average molecular weight (Mw) ranging from 21,000 to 40,000 Da as determined by size exclusion chromatography.

2. The process according to claim 1, wherein the compatibilizer has a melt index MI₂ ranging from 40 to 400 g/10 min as determined according to ISO 1133-2011 at 190° C. under a load of 2.16 kg.

3. The process according to claim 1, wherein the compatibilizer has a weight average molecular weight (Mw) ranging from 22,000 to 35,000 Da as determined by size exclusion chromatography.

4. The process according to claim 1, wherein the component B is or comprises one or more polymers having a polar functional group, wherein the polar functional group is at least one selected from the group consisting of a carboxyl group, a hydroxyl group, an epoxy group, an amino group, an amide group, a silyl group, an acetylacetonato group, and a mercapto group.

5. The process according to claim 1, wherein the component B is or comprises one or more polymers having a polar functional group selected from polyamide, ethylene vinyl alcohol, polyester, and any mixture thereof.

6. The process according to claim 1, wherein the component B is or comprises one or more carbon-containing particles selected from graphite, petroleum coke, carbon black, coke, carbon nanotubes, or a mixture thereof; and/or in that the component B is or comprises one or more materials having a polar functional group selected from cellulose derivative with a hydroxyl group, chitin, natural fibres and any blend thereof.

7. The process according to claim 1, wherein the one or more polyethylene resins of component A have a high load melt index (HLMI) of at least 1.0 g/10 min as determined according to ISO 1133-2011 at 190° C. under a load of 21.6 kg and/or a melt index (MI₂) of at most 20.0 g/10 min as determined according to ISO 1133-2005 at 190° C. under a load of 2.16 kg.

8. The process according to claim 1, wherein the one or more polyethylene resins of component A are or comprise one or more high-density polyethylene resins and have a density ranging from 0.940 g/cm³ to 0.965 g/cm³ as determined according to ISO 1183-1:2012 at 23° C.

9. The process according to claim 1, wherein the grafting agent is present in the compatibilizer at a content ranging from 0.9 to 4.0 wt. % based on the total weight of the compatibilizer.

10. The process according to claim 1, wherein the step of providing a compatibilizer being a grafted polyethylene further comprises the sub-step of grafting of a polyethylene-containing material to produce said compatibilizer, wherein said sub-step comprises
a) providing an extruder with one or more thermal regulation devices;
b) providing a polyethylene-containing material comprising at least 80 wt. % of polyethylene based on the total weight of the polyethylene-containing material;
c) providing a grafting agent in a content ranging from 0.8 to 10.0 wt. % based on the total weight of the polyethylene-containing material provided in step (b), wherein the grafting agent comprises at least one double bound per molecule;
d) extruding the polyethylene-containing material and the grafting agent to obtain a grafted polyethylene; wherein step (d) of extruding comprises a thermal treatment of the polyethylene-containing material at a maximum barrel temperature Ts of at least 315° C. in one or more hot zones of the extruder; and
e) recovering a grafted polyethylene being the compatibilizer.

11. The process according to claim 10, wherein the polyethylene-containing material is selected to have:
a high load melt index (HLMI R) of at least 1.0 g/10 min as determined according to ISO 1133-2011 at 190° C. under a load of 21.6 kg, a melt index (MI₂ R) of at most 0.45 g/10 min as determined according to ISO 1133-2011 at 190° C. under a load of 2.16 kg and a density of at least 0.940 g/cm³ as determined according to ISO 1183-1:2012 at 23° C.; or
a melt index (MI₂ R) ranging from 0.8 to 1.5 g/10 min as determined according to ISO 1133-2011 at 190° C. under a load of 2.16 kg and a density ranging from 0.910 g/cm³ to 0.930 g/cm³ as determined according to ISO 1183-1:2012 at 23° C.

12. The process according to claim 11, wherein the grafting agent comprises or consists of one or more functional monomers selected from maleic anhydride, glycidyl methacrylate, methyl methacrylate, acrylic acid, butyl acrylate, vinyl acetate, diethyl maleate, acrylamide, acrylonitrile, and any mixture thereof; and/or in that the grafting agent is provided in a content ranging from 1.5 to 4.0 wt. % based on the total weight of the polyethylene-containing material provided on step (b).

13. The process according to claim 1, wherein the process comprises:
providing from 40 to 60 wt. % of the component A based on the total weight of the polymer composition;
providing from 60 to 40 wt. % of the component B based on the total weight of the polymer composition; and
providing from 0.8 to 5 wt. % of the compatibilizer based on the total weight of the polymer composition.

14. A compatibilizer being a grafted polyethylene characterized in that it comprises at least 70 wt. % of polyethylene based on the total weight of the compatibilizer, and has:
a melt index MI₂ ranging from 25.0 to 450.0 g/10 min as determined according to ISO 1133-2011 at 190° C. under a load of 2.16 kg;
an Mw/Mn ranging from 2.0 to 4.5 as determined by size exclusion chromatography
a complex viscosity at 0.1 rad/sec at 190° C. of at most 25,000 Pa·s;
a grafting agent content ranging from 0.5 to 15.0 wt. % based on the total weight of the compatibilizer; and
a weight average molecular weight (Mw) ranging from 21,000 to 40,000 Da as determined by size exclusion chromatography:
with preference, the melt index MI₂ is ranging from 40.0 to 350.0 g/10 min.

15. The compatibilizer according to claim 14, wherein the compatibilizer has a melt index MI₂ ranging from 50.0 to 240.0 g/10 min as determined according to ISO 1133-2011 at 190° C. under a load of 2.16 kg; and/or a grafting agent content ranging from 1.1 to 3.0 wt. % based on the total weight of the compatibilizer.

16. The compatibilizer according to claim 15, wherein the compatibilizer has h a tan delta (G″/G′) at 0.1 rad at 190° C. of at least 10.0.
